(19) United States
(12) Patent Application Publication
(10) Pub. No.: US 2025/0069489 A1
(43) Pub. Date: Feb. 27, 2025

(54) CONTROLLING THE MONITORING OF A PERSON OR AN ENVIRONMENT

(71) Applicant: Essence SmartCare Ltd., Herzlia Pituach (IL)

(72) Inventors: Ohad AMIR, Herzlia (IL); Jonathan Mark SCHNAPP, Tel Aviv (IL)

(21) Appl. No.: 18/725,117

(22) PCT Filed: Dec. 28, 2022
(86) PCT No.: PCT/IL2022/051404

§ 371 Date: Jun. 27, 2024

(30) Foreign Application Priority Data
Dec. 30, 2021 (GB) 2119122.6

(51) Int. Cl. G08B 21/04; G08B 13/181; G08B 13/19; G08B 13/24

(52) U.S. Cl. CPC G08B 21/0492; G08B 13/181; G08B 13/19; G08B 13/2494; G08B 21/0415; G08B 21/0469; G08B 21/043

(57) ABSTRACT

Embodiments relate to a device and method of controlling monitoring of a person or an environment. The method comprises determining information about a person or an environment using an output of an operation of an active reflective wave detector configured to measure wave reflections from an environment. The method further comprises, based on the information, adapting one or more parameters of a triggering module used for starting a later operation of the active reflected wave detector to determine further information about the person or the environment, the later operation being started based on an output of a PIR motion detector that is arranged to monitor motion in the environment, the output indicating that a motion has occurred after said operation of an active reflective wave detector.

### RELATED APPLICATION/S

This application claims the benefit of priority of Great Britain Patent Application No. 2119122.6 filed on Dec. 30, 2021, the contents of which are incorporated herein by reference in their entirety.

### FIELD

The present disclosure relates to the monitoring of a person or an environment in particular monitoring involving a PIR motion detector and an active reflected wave detector.

### BACKGROUND

Motion sensors are designed to monitor a defined area, which may be outdoors (e.g., an entrance to a building, a yard, and the like), and/or indoors (e.g., within a room, in proximity of a door or window, and the like). Motion sensors may be used for security purposes, to detect intruders based on motion in areas in which no motion is expected, for example, an entrance to a home at night. Some monitoring systems employ a motion sensor in the form of a passive infrared (PIR) detector to sense the motion (and by implication presence) of a heat-radiating body (i.e., such a heat-radiating body could be indicative of the presence of an unauthorized person) in its field of view. Depending on the particular system, the system may then issue an alarm such as an audible alarm sound, transmit a notification alerting another device of a detected event, and/or take another action, responsive to the detection of the moving body.

Other sensors can be used to monitor the defined area, such as active reflected wave detectors. One example of an active reflected wave detector is a radar ranging reflected wave detector but other types of active reflected wave detectors could be used.

### SUMMARY

According to a first aspect of the present disclosure there is provided a computer implemented method of controlling monitoring of a person or an environment, the computer implemented method comprising: determining information about a person or an environment using an output of an operation of an active reflective wave detector configured to measure wave reflections from an environment; and based on the information, adapting one or more parameters of a triggering module used for starting a later operation of the active reflected wave detector to determine further information about the person or the environment, the later operation is started based on an output of a PIR motion detector that is arranged to monitor motion in the environment.

In particular, there is provided a computer implemented method of controlling monitoring of a person or an environment, the computer implemented method comprising: determining information about a person or an environment using an output of an operation of an active reflective wave detector configured to measure wave reflections from an environment; and based on the information, adapting one or more parameters of a triggering module used for starting a later operation of the active reflected wave detector to determine further information about the person or the environment, the later operation being started based on an output of a PIR motion detector that is arranged to monitor motion in the environment, the output indicating that a motion has occurred after said operation of an active reflective wave detector.

Thus, advantageously, the monitoring of the person or the environment may be dynamically adapted based an output of the active reflected wave detector.

Further, by using the PIR motion detector to trigger a later (e.g. next) operation of the active reflected wave detector, the active reflected wave detector can be configured in a lower power state (e.g. off or asleep) and operate (by measuring wave reflections from the environment) in response to the PIR motion detector detecting motion in the environment. This is advantageous because typically the active reflected wave detector consumes more power in an operating state than the PIR motion detector in an operating state.

The starting of the later operation of the active reflected wave detector to determine further information about the person or the environment is performed by the triggering module. For example, the triggering module may provide one or more signals that activate the later operation of active reflected wave detector.

The later operation may be started upon expiry of a time window (also referred to herein as a PIR no-motion detection window) that commences in response to the PIR motion detector detecting motion, and during which no further motion is detected by the PIR motion detector.

In particular, the later operation may be started upon expiry of a time window (also referred to herein as a PIR no-motion detection window) that commences in response to the PIR motion detector detecting motion after said operation of the active reflective wave detector, and during which no further motion is detected by the PIR motion detector.

Thus advantageously, power may be conserved in some embodiments because if no motion is detected for a predetermined amount of time (defined by the PIR no-motion detection window), then (and only then) is the later operation of the active reflected wave detector triggered, such as in an embodiments in which the active reflective wave detector is used to determine whether a person is in a fall state or a some other static or mostly static state or activity (e.g. sleeping, watching television). It may for example be beneficial to look for such a state or activity once it is determined that a person is in involved in a locomotory state or engaged in a locomotory activity, as such a locomotory state or activity may eventually lead to the static or usually static state or activity.

Determining information about a person or an environment may comprises attempting to identify a state of a person, wherein in an event of identifying a state of a person, the method comprises setting the one or more parameters of the triggering module according to the state of the person. The information about a person or an environment may comprise a state of the person at a first time. Further, the method may comprise determining, based on the later operation of the active reflected wave detector, later information about the person or the environment (i.e. information about the person or the environment at a later time), e.g. an activity or state, or more specifically a state in some embodiments, of the person during the later operation.

By knowing the presumed current state of the person (i.e. the state of the person at the first time) it is possible to predict the likely movement types that may occur while remaining in that state or the likely movement types required to leave that state. The various movement types can be characterized by the size of the motion (distance travelled), the magnitude of the signal (e.g. how much surface area at a different temperature to the background is moving) and/or the speed of the motion. The parameters of the triggering module, which relate to the PIR motion detector, may then be set such that the PIR is motion detector is either sensitive to detecting the likely movement types to thereby provide a level of confirmation that the person is still the same state, or insensitive to detecting the likely movement types to thereby provide save power by not triggering the active reflected wave detector while the person remains in the same state.

For example, in some scenarios in which the person is in a state or performing an activity that involves low levels of movement (e.g. if they are one or more of: in a non-locomotory state, in a usually static, engaged in a non-locomotory activity and/or engaged in a usually static activity), it may be desirable to verify that a person is in the same state as at the first time. This may be achieved by adapting one or more parameters of the PIR motion detector to have a high motion detection sensitivity, in order words a motion detection sensitivity that is adapted for detecting movements that are typical while the person is in the state of the person at the first time. Additionally or alternatively, the method may comprise setting the PIR no-motion detection window to a long time at least as long as expected regularity of movements in that that state or while performing that activity (which may for some states/activities be longer than, or at least as long as, when the person is in involved in a locomotory state or engaged in a locomotory activity), so as to avoid operating the active reflected wave detector while the PIR motion detector detects motion during that time.

Alternatively, by adapting one or more parameters of the PIR motion detector based on the state of the person at the first time the PIR detector may thereby be made to have a low sensitivity to detecting motion in response to movement that occurs while in same state as at the first time so that the later operation of the active reflected wave detector may, for example, be used to confirm that the person is no longer still in the same state as the first time, e.g. by identifying, based on the output of the later operation, a different state that the person is in. The idea is that, with the adapted parameters, the PIR motion detector is unlikely to detect motion so long as the person remains in the same state as at the first time. Optionally it may be identified that the person is no longer in the same state as at the first time by identifying an activity that the person is performing which is inconsistent with, or unlikely to coincide with, the person being in same state as at the first time, e.g. vacuuming while lying down. Alternatively, where the state at the first time and the later time are both static states and the same state (e.g. both a sitting state), it may be determined that the person had temporarily been in a different state between the first time and the later time.

In some embodiments, depending on the person's current state, it may be beneficial to have the PIR motion configured to easily, or more easily than a prior configuration, detect small and/or slow movements. For example, if a person is in a lying state (e.g. lying on a bed) it could be assumed they are resting or sleeping, and so any movements within the bed are likely to be relatively small (i.e. over short distance) compared with more mobile states such as while the person is walking.

Making the PIR motion detector sensitive to detecting these small movements can advantageously be used to confirm this resting/state of the person. In another example, if a person is in a standing state and standing still the parameter values of the PIR motion detector might undesirably result in the PIR motion detector not being sensitive enough to detect motion of the person falling down after standing still. Similarly, falls from a bed might go undetected. Thus if it is determined that the person is in a still sate from which they may fall, the one or more parameters of the PIR motion detector may be controlled to make the PIR motion detector sensitive to motion caused by a person falling. This may involve a more sensitive PIR motion detector compared to at least one other scenario.

Further, when the person is lying on the floor (e.g. they are in a fall state) the type of movement expected is relatively small and slow movements, and the slowness of the movements translates to low frequency signals. It may be desirable to detect such movements to know if the person is moving at all or not. Therefore detecting motion in such scenarios may be improved by setting the PIR motion detector to have a relatively higher gain in respect of low frequency signals. To still enable capturing of faster motions a normal gain may still be applied for high frequency signals. Thus, in some embodiments herein, detection of these movements may, for example, be achieved by controlling the gain and/or frequency response profile of a gain stage of the PIR motion detector.

Conversely, in some embodiments, one or more parameters of the PIR motion detector can be adapted based on the state of the person at the first time so that small and/or slow movements performed from this state are not detected by the PIR motion detector (e.g. by decreasing the sensitivity of the PIR motion detector, relative to at least one other scenario). For example if a person is in a lying state (e.g. lying on a bed) the PIR motion detector can be made less sensitive (relative to at least one other scenario) on the basis that it may not be desirable to trigger the PIR motion detector from movements during sleeping, to advantageously conserve the regularity with which the active reflected wave detector wakes up and therefore consumes power.

The PIR motion detector may comprise an optical component comprising a plurality of lenses. The method may comprise identifying that infrared radiation from the person will be incident on a subset of the plurality of lenses based on the determined state of the person at the first time and adapting one or more parameters of the PIR motion detector based on the subset of the plurality of lenses. For example, when the person is lying on the floor (e.g. they have fallen) it can be expected that IR radiation from the person will be captured by one or more of the lenses that provide the PIR motion detector with a view of the floor and not by lenses having only a more elevated field of view that does not include the floor. Thus, one or more parameters of the PIR motion detector can be optimized for one or more lenses for which the person in a known state (e.g. a lying on the floor or in a fall state) may be in the field of view of the PIR motion detector, so as to better detect motions while the person is the state.

Determining information about a person or an environment may comprise attempting to identify an activity being performed by a person, wherein in an event of identifying an activity being performed by a person, the method may comprise setting the one or more parameters of the triggering module according to the activity.

The information about a person or an environment may comprise an activity being performed by the person at a first time (e.g. what they are engaged in or what they are doing). Further, the later operation of the active reflected wave detector may be used determine later information about the person or the environment, e.g. a state or activity, or more specifically an activity in some embodiments, of the person during the later operation. Similar adaptations to those described above may be made in relation to activities performed by a person in the environment such as watching TV, eating, conversing, walking and playing an instrument.

Determining information about a person or an environment may comprise attempting to identify a position of a person relative to the PIR motion detector, wherein in an event of identifying a position of a person relative to the PIR motion detector the method may comprise setting the one or more parameters of the triggering module according to the identified position of the person relative to the PIR motion detector.

The identified position of the person relative to the PIR motion detector may comprise a determined distance of the person from the PIR motion detector.

Optionally the distance may be with respect to a specific axis or plane, for example the distance may be a horizontal radial distance. In other embodiments, the distance may be a radial distance in 3-dimensional space.

The PIR motion detector may be configured for a range of distances from the PIR motion detector in which the PIR motion detector is expected to detect motion of a person, based on the position of the person. In particular, in some implementations the one or more parameters configure motion detection performed by the PIR motion detector, and the adapting the one or more parameters configures the motion detection for a range of distances from the PIR motion detector in which the PIR motion detector is expected to detect motion of a person, based on the identified position of the person.

Optionally, the PIR motion detector may be configured for said range of distances by tailoring a frequency response profile of the PIR motion detector based on said position of the person. In particular, in some implementations the adapting the one or more parameters configures the motion detection for said range of distances by tailoring the frequency response profile of the PIR motion detector based on the identified position of the person (e.g. by controlling the at least one frequency response profile parameter).

For example, by knowing the distance of the person from the PIR motion detector, one or more parameters of the PIR motion detector can be adapted to change a frequency range of the PIR motion detector from one configured for detecting motion anywhere between a maximum and minimum distance range for monitoring a whole space (i.e. when the person's location is unknown) to a narrower frequency range configured for a smaller range of distances in which the person is known to be located. For example if it is assumed the person may walk up to 7 km/hour and it is desirable to detect this, 7 km/hour would correspond to a higher frequency signal when the person is closer to the PIR motion detector than when the person is further from the PIR motion detector. The same applies to any lower speed limits that to be detected. Based on knowing the relevant frequencies for the given distance from the PIR motion detector, the electronics transfer function implemented by the PIR motion detector can be tailored to be for those frequencies. For example, frequencies outside that range can be ignored (or at least treated with a comparatively lower gain) based on the assumption that when the PIR motion detector next detects the person they will be at (or at least close to) the same location.

The method may comprise identifying that infrared radiation from the person will be incident on a subset of the plurality of lenses based on the determined distance of the person from the PIR motion detector and adapting one or more parameters of the PIR motion detector based on the subset of the plurality of lenses. Thus, one or more parameters of the PIR motion detector can be optimized for the subset of the plurality of lenses that can view the distance.

Additionally or alternatively, the identified position of the person relative to the PIR motion detector may comprise a determined orientation of the person with respect to a principal axis of at least one lens of the PIR motion detector.

Depending on the orientation of the person, small movements of the person may not involve a change in the total infrared light within the field of view from a given lens, and therefore might not result in a detectable change by the PIR motion detector. However, were the person perpendicular to the principal axis of the fields of view from the respective lenses, they would more likely fall within the fields of view from multiple lenses than if they were parallel to the principal axis. This would result in a higher likelihood that a small movement would result in at least one of the lenses providing a change in received IR light. For this reason, where the PIR motion detector is configured to be used such that the principal axis of the fields of view is generally horizontal, then for a person in a state of lying on the floor (in a position consistent with a fall, or being in an elevated lying position such as in a bed) small movements by the person may be less likely to be detected compared with when they are standing. By adapting one or more parameters of the PIR motion detector these small movements may advantageously be more detectable. Also, a person lying in an axis that is relatively parallel to the principal axis of the lens's field of view may result in the person occupying a smaller percentage of the field of view of a transducer of the PIR motion detector than if they were perpendicular to the principal axis of the lens's field of view. For this reason a person in a state of lying on the floor (in position consistent with a fall, or being in an elevated lying position such as in a bed) may result in a lower strength IR signal from the transducer than if were they standing. This may support using a larger gain in the gain stage of the PIR motion detector for such lying configurations compared with standing configurations, which are used for at least one other scenario. Further if the person occupies a higher percentage from a given lens's field of view, then small movements may be more likely to result in a change in that percentage, thereby resulting in a detectable motion.

Additionally or alternatively, the position of the person relative to the PIR motion detector may comprise a determined spatial distribution of the person.

Additionally or alternatively, the position of the person relative to the PIR motion detector may comprise a determined height of the person above a floor of the environment.

The information about the person or the environment may comprise information indicative of whether the person is or is not present in a monitoring region of the environment which is monitored by the active reflective wave detector, and in an event that the person is not present the method may comprise setting the one or more parameters of the triggering module to predetermined values associated with a vacant monitoring region.

If it is determined that no person is present in the environment one or more parameters of the PIR motion detector can be adapted to decrease the sensitivity of the PIR motion detector (e.g. relative to a scenario in which a person is in a locomotory state or engaged in a locomotory activity), or decreasing the sensitivity at least at high frequencies, so as to minimize the risk of false alarms from other (non-human) objects that may move. In this implementation, the one or more parameters of the PIR motion detector are adapted in such a way that the PIR motion detector would still to be sensitive enough to identify when a person re-enters the environment.

The one or more parameters may configure motion detection performed by the PIR motion detector. For example, the triggering module may correspond to one or more processing stages of the PIR motion detector, and a parameter of the one or more processing stages may be adapted, based on the determined information about a person or an environment, to configure motion detection performed by the PIR motion detector.

The one or more parameters may comprise one or more of:
a gain parameter defining a gain provided by a gain stage of the PIR motion detector;
at least one threshold parameter, the at least one threshold parameter defining at least one threshold used in a comparator stage of the PIR motion detector;
at least one frequency response parameter defining a frequency response profile of a gain stage of the PIR motion detector; and
a parameter defining a number of times a threshold used in a comparator stage of the PIR motion detector must be exceeded to detect motion.

The method may comprise determining a scenario based on the information; and the adapting one or more parameters of the triggering module may comprise setting the one or more parameters based on the determined scenario.

The methods described herein may be performed by at least one processor. The at least one processor may comprise the triggering module in embodiments whereby adapting the one or more parameters of the triggering module comprises setting the length of the time window based on the determined scenario.

Determining information about a person or an environment may comprise attempting to identify a state of a person or an activity performed by a person, and in an event of the scenario comprising a person being in a locomotory state or a person performing a locomotory activity, the method may comprise setting the one or more parameters of the triggering module to respective predetermined values associated with the locomotory state or activity.

Determining information about a person or an environment may comprises attempting to identify a state of a person or an activity performed by a person, and in an event of the scenario comprising a person being in a non-locomotory state or a person performing non-locomotory activity (e.g. the person maintains a stationary location but is in a state in which, or performing an activity, in which they are usually moving one or more body parts), the method may comprise setting the one or more parameters of the triggering module to control the PIR motion detector to be less sensitive to motion than when the one or more parameters of the triggering module are set to predetermined values associated with at least one other scenario.

Optionally, the sensitivity of the PIR motion detector to small and/or slow movements (i.e. low frequency signals output by the transducer of the PIR motion detector) may be adapted in response to determining that the person is in a non-locomotory state or performing a non-locomotory activity (e.g. that they are eating). This can be performed in different ways.

In one implementation, one or more parameters of the PIR motion detector can be adapted to increase the sensitivity of the PIR motion detector (relative to at least one other scenario) to small and/or slow movements to ensure that the non-locomotory activity (e.g. eating) is continually sensed by the PIR motion detector, and hence the PIR no-motion detection window used to trigger the active reflected wave detector is continuously restarted before it expires. This implementation has an advantage of positively determining the person is active.

In another implementation, one or more parameters of the PIR motion detector can be adapted to decrease the sensitivity of the PIR motion detector (relative to at least one other scenario) to small and/or slow movements so that the non-locomotory activity (e.g. eating) is not even detected. Thus, the PIR motion detector is only triggered once the person finishes the non-locomotory activity (in the case of eating this presumes they are stationary while eating) and starts walking. This may thereby avoid repetitive determinations that the person is ta non-locomotory activity, while the person is the non-locomotory activity. This implementation may thereby have an advantage of saving more power.

Determining information about a person or an environment may comprise attempting to identify a state of a person or an activity performed by a person, and in an event of the scenario comprising a person in a usually static state or person performing a usually static activity, the method may comprises: setting the one or more parameters of the triggering module to control the PIR motion detector to be less sensitive to motion than when the one or more parameters of the triggering module are set to predetermined values associated with at least one other scenario.

The usually static state or a usually static activity may correspond to the person sleeping. The PIR motion detector can be made less sensitive (relative to at least one other scenario) on the basis that, for some industrial applications, it may be desirable not to trigger the PIR motion detector from movements during sleeping, so as to conserve power. In some embodiments the usually static state or activity may be one or more of a fall state, lying state, a safe resting state (e.g. lying in in elevated position from the ground, such as on a reclined chair, couch or bed), sleeping, a sitting state, or a standing still state. In some embodiments, the usually static state may be more narrowly limited to a sleeping or resting state, or yet more narrowly to a sleeping state.

In implementations described herein, no distinction is made as to whether a person is sleeping or merely resting based solely on wave reflections measured by the active reflective wave detector. For example, if, from wave reflections measured by the active reflective wave detector, it is only determined that a person is lying down in an elevated position, this may suggest that they are sleeping in a bed, however they could be merely resting in bed or not in a bed at all (e.g. resting on a sofa). Thus optionally, it may, for the purposes herein, be determined (at least by assumption) that the person is sleeping (rather than resting) based on one or more other additional factors such as the time of day, a duration for which they are determined to have remained at the same location, and/or known patterns of behaviour of the person.

Preferably, in response to controlling the PIR motion detector to be less sensitive to motion, the PIR motion detector is able to detect at least one of: (i) larger movements than movements detectable by the PIR motion detector when the one or more parameters of the triggering module are set to the predetermined values; (ii) faster movements than movements detectable by the PIR motion detector when the one or more parameters of the triggering module are set to the predetermined values; and (iii) movements of more surface area of a different temperature to a background than movements detectable by the PIR motion detector when the one or more parameters of the triggering module are set to the predetermined values.

Determining information about a person or an environment may comprise attempting to identify a state of a person or an activity performed by a person, and in an event of the scenario comprising a person being in a usually static state or a person performing a usually static activity, the method may comprise:
setting the one or more parameters of the triggering module to confirmation setting values, for confirming that the person is still in a usually static state or performing a usually static activity, to control the PIR motion detector to be more sensitive to motion than when the one or more parameters of the triggering module are set to predetermined values associated with at least one
determining whether a predefined condition has been met, the predefined condition relating to motion detections detected by the PIR motion detector; and
if the predefined condition has been met, setting the one or more parameters of the triggering module to control the PIR motion detector to be less sensitive to motion than when the one or more parameters of the triggering module are set to the confirmation setting values.

Preferably, in response to controlling the PIR motion detector to be more sensitive to motion, the PIR motion detector is able to detect at least one of: (i) smaller movements than movements detectable by the PIR motion detector when the one or more parameters of the triggering module are set to the predetermined values; (ii) slower movements than movements detectable by the PIR motion detector when the one or more parameters of the triggering module are set to the predetermined values; and (iii) movements of less surface area of a different temperature to a background than movements detectable by the PIR motion detector when the one or more parameters of the triggering module are set to the predetermined values.

Preferably, in response to controlling the PIR motion detector to be less sensitive to motion, the PIR motion detector is less able to detect at least one of: (i) smaller movements than movements detectable by the PIR motion detector when the one or more parameters of the triggering module are set to the confirmation setting values; (ii) slower movements than movements detectable by the PIR motion detector when the one or more parameters of the triggering module are set to the confirmation setting values; and (iii) movements of less surface area of a different temperature to a background than movements detectable by the PIR motion detector when the one or more parameters of the triggering module are set to the confirmation setting values.

The one or more parameters may define a length of the time window (the PIR no-motion detection window).

The method may comprise determining a scenario based on the information; and the adapting one or more parameters of the triggering module may comprise setting the length of the time window based on the determined scenario.

The information about the person or the environment may comprise information indicative of whether the person is or is not present in a monitoring region of the environment which is monitored by the active reflective wave detector, and in an event that a person is not present the method may comprise setting the length of the time window to a predetermined value associated with a vacant monitoring region.

Determining information about a person or an environment may comprise attempting to identify a state of a person or an activity performed by a person, and in an event of the scenario comprising a person being in a locomotory state or a person performing a locomotory activity, the method may comprise setting the length of the time window to a predetermined value associated with the locomotory state or activity.

For example, if it is determined that the person is in a locomotory state, e.g. walking, crawling, etc. power may be saved by only next operating the active reflected wave detector once there is a substantial period of no motion detection (e.g. 45 seconds +−15 seconds or +/−20 seconds, indicating the person has transitioned to a static state. Meanwhile while the person continues moving power is conserved by not operating the active reflected wave detector, since it is known the person is still locomotory based on the relatively frequent PIR motion detections.

Determining information about a person or an environment may comprise attempting to identify a state of a person or an activity performed by a person, and in an event of the scenario comprising a person being a non-locomotory state or a non-locomotory activity, the method may comprise setting the length of the time window to be less than a predetermined value associated with at least one other scenario.

Determining information about a person or an environment comprises attempting to identify a state of a person or an activity performed by a person, and in an event of the state or activity being a usually static state or a usually static activity, the method comprises setting the length of the time window to be less than a predetermined value associated with at least one other scenario.

By making the PIR no-motion detection window small (close to zero) or zero, once the PIR motion detector detects motion, the active reflected wave detector is immediately activated to quickly see what is going on in the environment. The usually static state or a usually static activity may correspond to the person sleeping.

As noted above, the PIR motion detector can be made less sensitive (relative to at least one other scenario) on the basis that it may not be desirable to trigger the PIR motion detector from movements during sleeping. With such PIR setting if you are detecting motion it's likely not due to the small motions like sleep motions, so it means that there's a good chance the movement is due to something else, namely that they have gotten up and are walking (or perhaps that they have fallen out of bed). By making the PIR no-motion detection window small (close to zero) or zero the person can be quickly assessed.

Determining information about a person or an environment may comprise attempting to identify a state of a person or an activity performed by a person, and in an event of the scenario comprising a person being in a usually static state or a person performing a usually static activity, the method may comprise:
setting the one or more parameters of the triggering module to confirmation setting values to control the PIR motion detector to be more sensitive to motion than when the one or more parameters of the triggering module are set to predetermined values associated with at least one other scenario;
determining whether a predefined condition has been met, the predefined condition relating to motion detections detected by the PIR motion detector; and
if the predefined condition has been met, setting the length of the time window to a predetermined value associated with a locomotory state or activity.

Preferably, in response to controlling the PIR motion detector to be more sensitive to motion, the PIR motion detector is able to detect at least one of: (i) smaller movements than movements detectable by the PIR motion detector when the one or more parameters of the triggering module are set to the predetermined values; (ii) slower movements than movements detectable by the PIR motion detector when the one or more parameters of the triggering module are set to the predetermined values; and (iii) movements of less surface area of a different temperature to a background than movements detectable by the PIR motion detector when the one or more parameters of the triggering module are set to the predetermined values

In an event of the scenario comprising a person being in a usually static state or a person performing a usually static activity, the method may comprise setting the length of the time window to be greater than a predetermined value associated with at least one other scenario.

The predefined condition may comprise at least one of: a number of motion detections detected by the PIR motion detector within a predetermined time period exceeds a first threshold; and a time between successive motion detections detected by the PIR motion detector is below a second threshold.

The at least one other scenario referred to above may comprise a scenario associated with a person being in a locomotory state or a person performing a locomotory activity.

Alternatively, or additionally, the at least one other scenario referred to above may comprise a scenario associated with a person not being present in the environment. The method may comprise determining that a single person is present in the environment, wherein one or more parameters of the triggering module are assigned according to the state of, or activity performed by, the person.

The method may comprise determining that multiple people are present in the environment. In some embodiments the one or more parameters of the triggering module may be assigned according to a scenario for which the one or more parameters would be set such that the PIR motion detector would have a relatively low sensitivity, e.g. the one or more parameters may be set to the same values as for when the room is vacant.

According to another aspect of the present disclosure there is provided at least one non-transitory computer-readable storage medium comprising instructions which, when executed by at least one processor causes the at least one processor to perform any of the methods described herein.

The instructions may be provided on one or more carriers. For example there may be one or more non-transient memories, e.g. a EEPROM (e.g. a flash memory) a disk, CD-or DVD-ROM, programmed memory such as read-only memory (e.g. for Firmware), one or more transient memories (e.g. RAM), and/or a data carrier(s) such as an optical or electrical signal carrier. The memory/memories may be integrated into a corresponding processing chip and/or separate to the chip. Code (and/or data) to implement embodiments of the present disclosure may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language.

According to another aspect of the present disclosure there is provided a device for method of controlling the monitoring of a person or an environment, the device comprising:
a processor, wherein the processor is configured to:
determine information about a person or an environment using an output of an operation of an active reflective wave detector configured to measure wave reflections from an environment; and based on the information, adapt one or more parameters of a triggering module used for starting a later operation of the active reflected wave detector to determine further information about the person or the environment, the later operation is started based on an output of a PIR motion detector that is arranged to monitor motion in the environment.

In particular, there is provided a device for method of controlling monitoring of a person or an environment, the device comprising:
a processor, wherein the processor is configured to:
determine information about a person or an environment using an output of an operation of an active reflective wave detector configured to measure wave reflections from an environment; and based on the information, adapt one or more parameters of a triggering module used for starting a later operation of the active reflected wave detector to determine further information about the person or the environment, the later operation being started based on an output of a PIR motion detector that is arranged to monitor motion in the environment, the output indicating that a motion has occurred after said operation of an active reflective wave detector.

The individual features and/or combinations of features defined above in accordance with any aspect of the present disclosure or below in relation to any specific embodiment of the disclosure may be utilised, either separately and individually, alone or in combination with any other defined feature, in any other aspect or embodiment of the disclosure.

These and other aspects will be apparent from the embodiments described in the following. The scope of the present disclosure is not intended to be limited by this summary nor to implementations that necessarily solve any or all of the disadvantages noted.

### BRIEF DESCRIPTION OF THE SEVERAL VIEWS OF THE DRAWINGS

For a better understanding of the present disclosure and to show how embodiments may be put into effect, reference is made to the accompanying drawings in which:

FIG. 1 illustrates an environment in which a device has been positioned;

FIG. 2 is a schematic block diagram of the device;

FIGS. 3a and 3b illustrates a human body with indications of reflections measured by a reflective wave detector when the person is in a standing non-fall state and in a fall state;

FIG. 4 is a schematic representation of a passive infrared (PIR) motion detector;

FIG. 5 is a plan view of an environment illustrating people moving in directions tangential to arcs of the lenses of a PIR motion detector;

FIG. 6 is side view of an environment illustrating how different rows of lenses of a PIR motion detector may detect different people which are at different distances from the PIR motion detector;

FIG. 7 is side view of an environment illustrating how different rows of lenses of a PIR motion detector may detect different people which are at different heights above the floor;

FIG. 8 illustrates a side view of an environment comprising two people both positioned sufficiently far away from a PIR motion detector such that the same row of lenses PIR motion detector detects motion of both people;

FIG. 9 illustrates, with reference to the arrangement shown in FIG. 8, a cross section of a field of view of a lens with the closest person in the field of view;

FIG. 10 illustrates, with reference to the arrangement shown in FIG. 8, a cross section of a field of view of a lens with the furthest away person in the field of view;

FIG. 11 illustrates people at different orientations with respect to a principal axis of at lens of a PIR motion detector;

FIG. 12 is an illustration of a gain vs frequency profile of a PIR motion detector;

FIG. 13 is a flowchart illustrating a method for controlling the monitoring of an environment;

FIG. 14 is a flowchart illustrating a further method for controlling the monitoring of an environment;

FIG. 15 is a flowchart illustrating another method for controlling the monitoring of an environment;

FIG. 16 is a flowchart illustrating a method for setting one or more parameters of a triggering module of the device according to the state and/or activity of the person being locomotory;

FIG. 17 is a flowchart illustrating a method for setting one or more parameters of a triggering module of the device according to the state and/or activity of the person being non-locomotory; and

FIG. 18 is a flowchart illustrating a method for setting one or more parameters of a triggering module of the device in dependence on whether a person in the environment has remained in a usually static state or remained performing a usually static activity.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized, and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims and their equivalents. In the following embodiments, like components are labelled with like reference numerals. In the following embodiments, the term data store or memory is intended to encompass any computer readable storage medium and/or device (or collection of data storage mediums and/or devices). Examples of data stores include, but are not limited to, optical disks (e.g., CD-ROM, DVD-ROM, etc.), magnetic disks (e.g., hard disks, floppy disks, etc.), memory circuits (e.g., EEPROM, solid state drives, random-access memory (RAM), etc.), and/or the like. Further, a data store or memory may be comprised of a single medium/device or a plurality of mediums/devices, optionally comprising a plurality of different mediums/devices.

As used herein, except wherein the context requires otherwise, the terms “comprises”, “includes”, “has” and grammatical variants of these terms, are not intended to be exhaustive. They are intended to allow for the possibility of further additives, components, integers or steps.

The functions or algorithms described herein are implemented in hardware, software or a combination of software and hardware in one or more embodiments. The software comprises computer executable instructions stored on computer readable carrier media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor.

Specific embodiments will now be described with reference to the drawings.

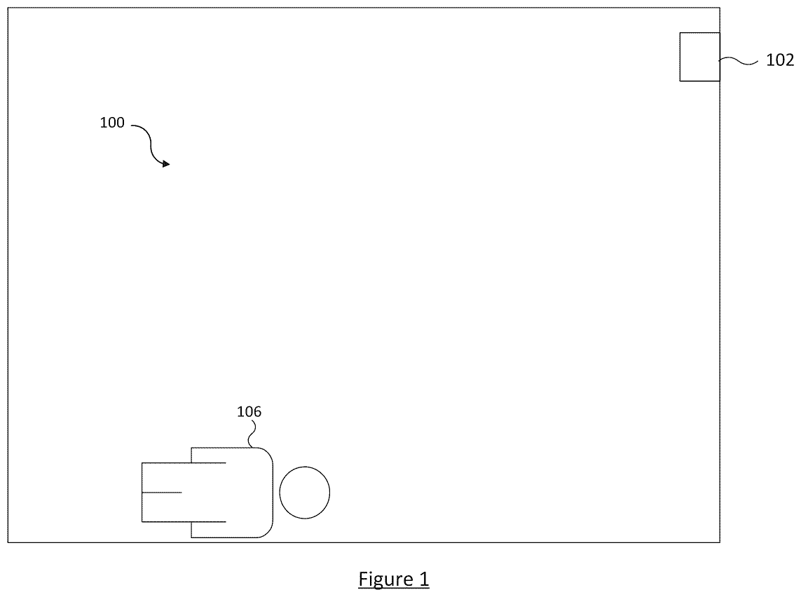

FIG. 1 illustrates an environment 100 in which a device 102 has been mounted to a wall. It will be appreciated that the device may also be mounted to a ceiling or on a post away from the ceiling and walls. The environment 100 may for example be an indoor space such as a room of a home, a nursing home, a public building or other indoor space.

The device 102 may be used to detect a person 106 having fallen (that is, being in a fall position) which is illustrated in FIG. 1.

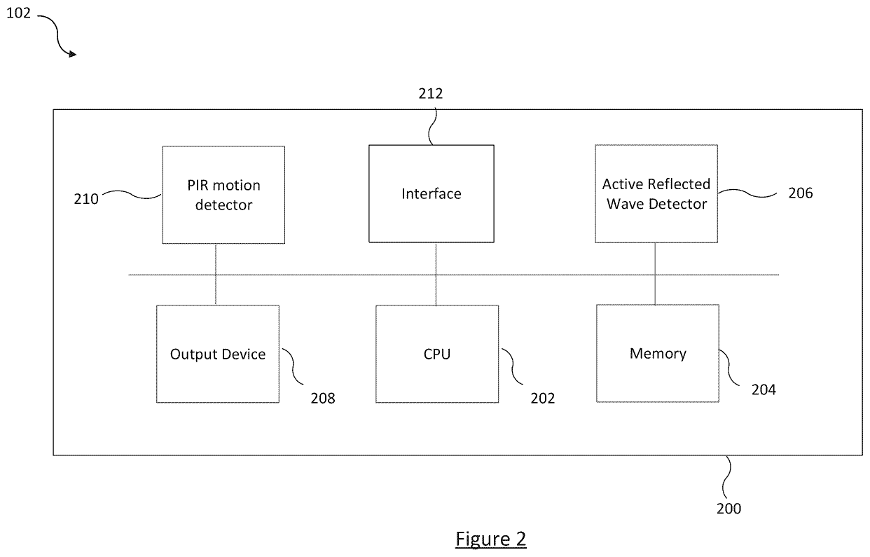

FIG. 2 illustrates a simplified view of the device 102. A shown in FIG. 2, the device 102 comprises a central processing unit (“CPU”) 202, to which is connected a memory 204. The functionality of the CPU 202 described herein may be implemented in code (software) stored on a memory (e.g. memory 204) comprising one or more storage media, and arranged for execution on a processor comprising one or more processing units. The storage media may be integrated into and/or separate from the CPU 202. The code is configured so as when fetched from the memory and executed on the processor to perform operations in line with embodiments discussed herein.

Alternatively, it is not excluded that some or all of the functionality of the CPU 202 is implemented in dedicated hardware circuitry (e.g. ASIC(s), simple circuits, gates, logic, and/or configurable hardware circuitry like an FPGA). In other embodiments (not shown) a processing system executes the processing steps described herein, wherein the processing system may consist of the processor as described herein or may be comprised of distributed processing devices that may be distributed across two or more devices. Each processing device of the distributed processing devices may comprise any one or more of the processing devices or units referred to herein.

Any instance of referring to a CPU may alternatively be taken as a reference to a processing module which may be one or more software modules implemented on one or more processing devices and/or may be an item of hardware, e.g. a processing device or part thereof or a plurality of processing devices.

FIG. 2 shows the CPU 202 being connected to an active reflected wave detector 206 and a PIR motion detector 210.

While in the illustrated embodiment the active reflected wave detector 206 and the PIR motion detector 210 are separate from the CPU 202, in other embodiments, at least part of processing aspects of the active reflected wave detector 206 and the PIR motion detector 210 may be provided by a processor that also provides the CPU 202, and resources of the processor may be shared to provide the functions of the CPU 202 and the processing aspects of the active reflected wave detector 206 and the PIR motion detector 210. Similarly, functions of the CPU 202, such as those described herein, may be performed in the active reflected wave detector 206 and/or the PIR motion detector 210.

As shown in FIG. 2, a housing 200 of the device 102 may house the active reflected wave detector 206 and the PIR motion detector 210. Alternatively, the PIR motion detector 210 may be external to the device 102 and be coupled to the CPU 202 by way of a wired or wireless connection. Similarly, the active reflected wave detector 206 may be external to the device 102 and be coupled to the CPU 202 by way of a wired or wireless connection. Further, the outputs of the PIR motion detector 210 and/or active reflected wave detector 206 may be wirelessly received from/via an intermediary device that relays, manipulates and/or in part produces their outputs.

The device 102 may comprise a communications interface 212 for communication of data to and from the device 102. For example, the device 102 may communicate with a remote device via the communications interface 212. This enables an alert (e.g. a fall detection alert message) to be sent from the device 102 to a remote device (not shown in FIG. 1), which may be via a wireless connection. This remote device may for example be a mobile computing device (e.g. a tablet or smartphone) associated with a carer or relative. Alternatively the remote device may be a computing device in a remote location (e.g. a personal computer in a monitoring station). Alternatively the remote device may be a control hub in the environment 100 (e.g. a wall or table mounted control hub). The control hub may be a control hub of a system that may be monitoring system and/or may be a home automation system. The notification to the control hub is in some embodiments via wireless personal area network, e.g. a low-rate wireless personal area network. Additionally or alternatively, the device 102 may communicate, via the communications interface 212, with one or more of the active reflected wave detector 206 and the PIR motion detector 210 in embodiments in which such components are not housed in the housing 200 of the device 102. The device 102 may comprise an output device 208 to output a fall detection alert or other message. For example, the CPU 202 may control a visual output device (e.g. a light or a display) on device 102 to output a visual alert of the fall detection. Alternatively or additionally, the CPU 202 may control an audible output device (e.g. a speaker) on device 102 to output an audible alert of the fall detection.

In an activated state, the active reflected wave detector 206 operates to measure wave reflections from the environment.

The active reflected wave detector 206 may operate in accordance with one of various reflected wave technologies. In operation, the CPU 202 may use the output of the active reflected wave detector 206 to determine the presence of a target object (e.g. human).

The active reflected wave detector 206 is a ranging detector. That is, in contrast with Doppler-only detectors, the active reflected wave detector 206 is configured to determine the location of an object (e.g. a person) in its field of view. This enables the CPU 202 to track the location of an object in the environment and also to determine which detected object is nearest.

Preferably, the active reflected wave detector 206 is a radar sensor. The radar sensor 206 may use millimeter wave (mmWave) sensing technology. As will be appreciated, embodiments may additionally or alternatively be based on microwaves and/or other radio frequencies. The radar is, in some embodiments, a continuous-wave radar, such as frequency modulated continuous wave (FMCW) technology. Such a chip with such technology may be, for example, Texas Instruments Inc. part number iwr6843AOP. The radar may operate in microwave frequencies, e.g. in some embodiments a carrier wave in the range of 1-100 GHz (76-81 Ghz or 57-64 GHz in some embodiments), and/or radio waves in the 300 MHz to 300 GHz range, and/or millimeter waves in the 30 GHz to 300 GHz range. In some embodiments, the radar has a bandwidth of at least 1 GHz.

The active reflected wave detector 206 may comprise antennas for both emitting waves and for receiving reflections of the emitted waves, and in some embodiment different antennas may be used for the emitting compared with the receiving.

As will be appreciated the active reflected wave detector 206 is an “active” detector in the sense of it relying on delivery of waves from an integrated source in order to receive reflections of the waves. The active reflected wave detector 206 is not limited to being a radar sensor, and in other embodiments alternative ranging detectors may be used, for example the active reflected wave detector 206 may be a LIDAR sensor, or a sonar sensor.

The active reflected wave detector 206 being a radar sensor is advantageous over other reflected wave technologies in that radar signals may transmit through some materials, e.g. wood or plastic, but not others—notably water which is important because humans are mostly water. This means that the radar can potentially “see” a person in the environment even if they are behind an object of a radar-transmissive material. Depending on the material, this may not be the case for sonar or lidar.

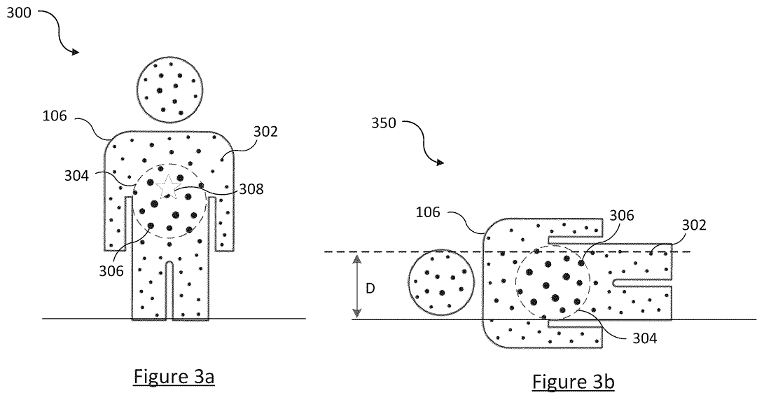

FIG. 3a illustrates a free-standing human body 106 with indications of reflective wave reflections therefrom in accordance with embodiments.

For each reflected wave measurement, for a specific time in a series of time-spaced reflective wave measurements, the reflective wave measurement may include a set of one or more measurement points that make up a “point cloud”. Each point 302 in the point cloud may be defined by a 3-dimensional spatial position from which a reflection was received, and defining a peak reflection value, and a doppler value from that spatial position. Thus, a measurement received from a reflective object may be defined by a single point, or a cluster of points from different positions on the object, depending on its size.

In some embodiments, such as in the examples described herein, the point cloud represents only reflections from moving points of reflection, for example based on reflections from a moving target. That is, the measurement points that make up the point cloud represent reflections from respective moving reflection points in the environment. This may be achieved for example by the active reflected wave detector 206 using moving target indication (MTI). Thus, in these embodiments there must be a moving object in order for there to be reflected wave measurements from the active reflected wave detector (i.e. measured wave reflection data), other than noise. The minimum velocity required for a point of reflection to be represented in the point cloud is less for lower frame rates. Alternatively, the CPU 202 receives a point cloud from the active reflected wave detector 206 for each frame, where the point cloud has not had pre-filtering out of reflections from moving points. Preferably for such embodiments, the CPU 202 filters the received point cloud to remove points having Doppler frequencies below a threshold to thereby obtain a point cloud representing reflections only from moving reflection points. In both of these implementations, the CPU 202 accrues measured wave reflection data which corresponds to point clouds for each frame whereby each point cloud represents reflections only from moving reflection points in the environment.

In other embodiments, no moving target indication (or any filtering) is used. In these implementations, the CPU 202 accrues measured wave reflection data which corresponds to point clouds for each frame whereby each point cloud can represent reflections from both static and moving reflection points in the environment. Even without removal of measurement points representing reflections from static objects the lower frame rate can still detect slower movements than at the higher frame rate.

FIG. 3a illustrates a map of reflections. The size of the point represents the intensity (magnitude) of energy level of the radar reflections (see larger point 306). Different parts or portions of the body reflect the emitted signal (e.g. radar) differently. For example, generally, reflections from areas of the torso 304 are stronger than reflections from the limbs. Each point represents coordinates within a bounding shape for each portion of the body. Each portion can be separately considered and have separate boundaries, e.g. the torso and the head may be designated as different portions. The point cloud can be used as the basis for a calculation of a reference parameter or set of parameters which can be stored instead of or in conjunction with the point cloud data for a reference object (human) for comparison with a parameter or set of parameters derived or calculated from a point cloud for radar detections from an object (human).

When a cluster of measurement points are received from an object in the environment 100, a location of a particular part/point on the object or a portion of the object, e.g. its centre, may be determined by the CPU 202 from the cluster of measurement point positions having regard to the intensity or magnitude of the reflections (e.g. a centre location comprising an average of the locations of the reflections weighted by their intensity or magnitude). As illustrated in FIG. 3a, the reference body has a point cloud from which its centre has been calculated and represented by the location 308, represented by the star shape. In this embodiment, the torso 304 of the body is separately identified from the body and the centre of that portion of the body is indicated. In alternative embodiments, the body can be treated as a whole or a centre can be determined for each of more than one body part e.g. the torso and the head, for separate comparisons with centres of corresponding portions of a scanned body.

In one or more embodiments, the object's centre or portion's centre is in some embodiments a weighted centre of the measurement points. The locations may be weighted according to an Radar Cross Section (RCS) estimate of each measurement point, where for each measurement point the RCS estimate may be calculated as a constant (which may be determined empirically for the reflected wave detector 206) multiplied by the signal to noise ratio for the measurement divided by R⁴, where R is the distance from the reflected wave detector 206 antenna configuration to the position corresponding to the measurement point. In other embodiments, the RCS may be calculated as a constant multiplied by the signal for the measurement divided by R⁴. This may be the case, for example, if the noise is constant or may be treated as though it were constant. Regardless, the received radar reflections in the exemplary embodiments described herein may be considered as an intensity value, such as an absolute value of the amplitude of a received radar signal.

In any case, the weighted centre, WC, of the measurement points for an object may be calculated for each dimension as:

$$W C = \frac{1}{{\sum }_{n = 1}^{N} {W}_{n}} {\sum }_{n = 1}^{N} ( {W}_{n} {P}_{n} )$$

### Where:

N is the number of measurement points for the object;
Wₙ is the RCS estimate for the n^{th} measurement point; and
Pₙ is the location (e.g. its coordinate) for the nth measurement point in that dimension.

The PIR motion detector 210 is configured to detect motion of an entity, particularly a human entity, in an environment.

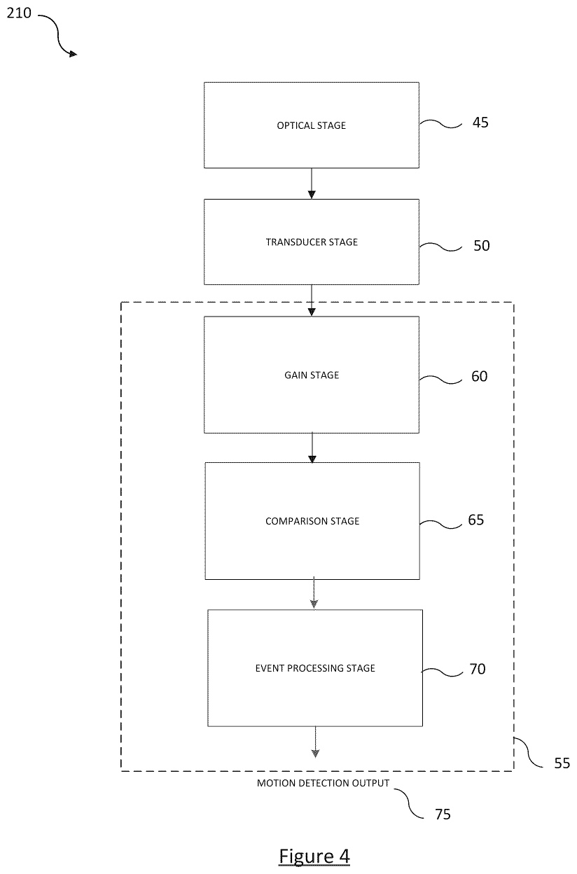

Exemplary functional stages of the PIR motion detector 210 are shown in FIG. 4. These are provided by way of example, and it will be appreciated that other arrangements of PIR detector could be used.

In this example, the PIR motion detector 210 comprises an optical stage 45 for providing an optical signal indicative of received IR radiation, a transducer stage 50 for transducing the optical signal provided by the optical stage 45 into an electrical signal, and a processing stage 55 for processing the electrical signal to determine whether or not the signal is indicative of motion (e.g. of human motion).

In examples, the optical stage 45 comprises a lens array formed from material that is transparent to IR radiation, wherein the lens array comprises an array of Fresnel lenses. The lens array may be in the shape of a dome, or in the shape of a hemicylindrical sheet and/or a half-dome.

The arrangement of the lens array may be considered as defining an optical transfer function that defines a transformation of moving IR radiation received at the optical stage 45 to the IR radiation signal provided to the transducer stage 50.

The transducer stage 50 is configured to receive the IR radiation from the optical stage 45 (specifically from the Fresnel lenses) and convert the IR radiation into at least one corresponding electrical signal. The transducer stage 50 could comprise, for example a pyroelectric sensor having positive and negative pyroelectric sensor elements each having a different field of view, and configured to output the electrical signal indicative of IR radiation received from the optical stage 45.

The processing stage 55 receives the electrical signal from the transducer stage 50 and is configured to determine if the electrical signal is indicative of motion, e.g. motion of a human.

The processing stage 55 comprises a gain stage 60, a comparison stage 65 and an event processing stage 70.

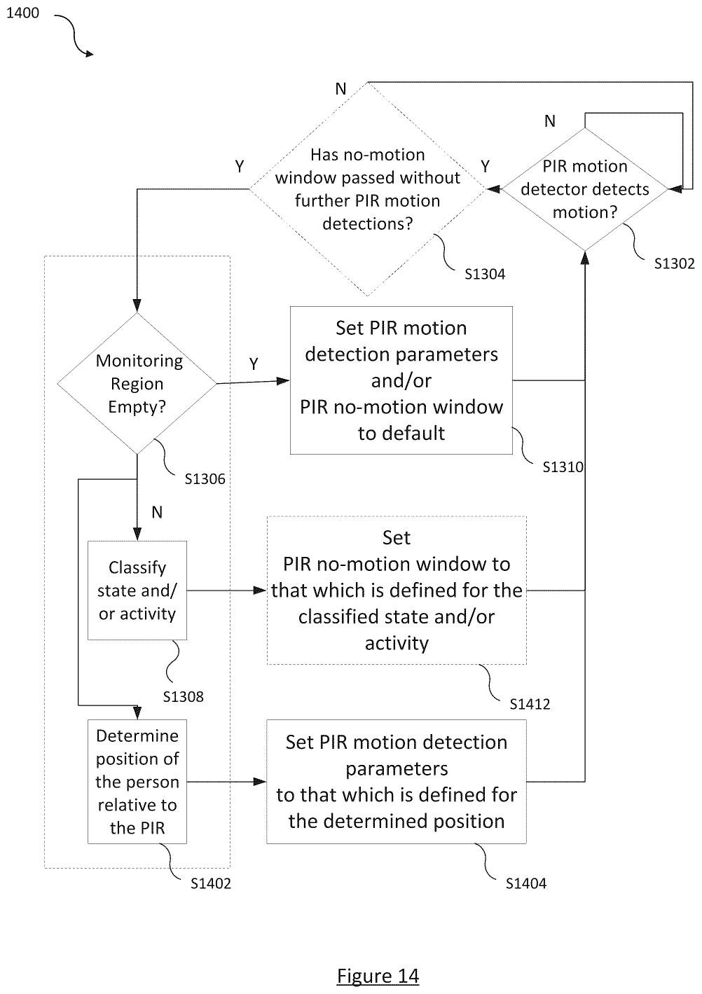

The gain stage 60 applies a gain to the electrical signal from the transducer stage 50. The gain stage 60 has a gain and frequency response profile that may be represented by a gain-stage transfer function. An example of an example of gain vs frequency transfer function is shown in FIG. 12. The gain may be modified uniformly across all frequencies or by changing the frequency response profile to have higher or lower gain at some frequencies compared with other frequencies. It will be appreciated that the gain stage may be implemented by analog and/or digital electronics, and/or in software, using any technique known by the person skilled in the art.

The output from the gain stage 60 is provided to the comparison stage 65 that compares the output from the gain stage 60 to one or more thresholds in order to identify occurrences of the output of the gain stage exceeding one or more thresholds. The comparison may be performed by electronics or in software. The comparison may be with respect to a single threshold. This may be the case, for example, where the output of the gain stage 60 is an absolute value. In other embodiments, a positive and a negative thresholds may respectively be used to compare the output of the gain stage 60. Further, optionally different thresholds may be used for different frequency ranges.

The event processing stage 70 receives indications of the respective threshold-crossing occurrences identified by the comparison stage 65 and applies defined or predefined logic specifying one or more conditions to be met to give a determination of the presence of motion, e.g.

motion of a human, or otherwise. If the occurrences of threshold-crossings identified by the comparison stage 65 meet the conditions, then a signal indicative of motion detection 75 is output from the event processing stage 70. If the occurrences of threshold-crossings identified by the comparison stage 65 do not meet the conditions, then it is determined that no motion, e.g. motion of a human, is present. An example condition is that there must be more than a predetermined number of threshold crossings within a predefined time period. For example, the predetermined number N may be greater than 1 (e.g. 2 or 3) to aid against identifying noise as motion. The predefined time period (T), may optionally be correlated with the low frequency cut-off (fc) of the PIR's frequency response, for example such that N/fc<T.

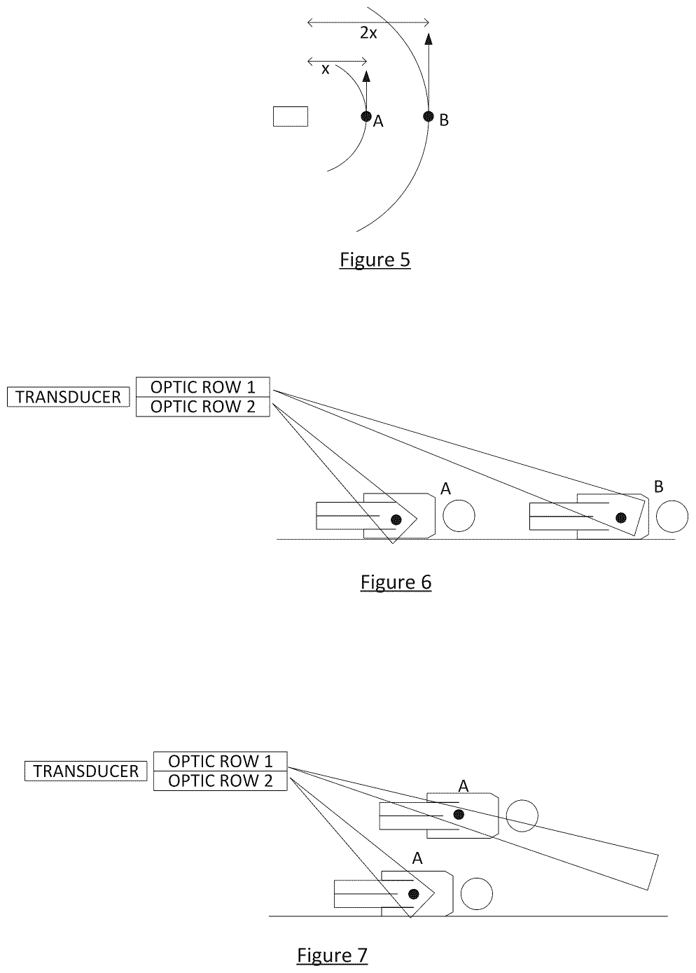

Motion is detected in directions tangential the arcs that are centered at the lens, whereby a person twice the distance from the PIR motion detector 210 will need to travel at twice the speed for the transducer stage to illicit a signal having the same time separation between successive positive and negative going peaks (i.e. the same signal frequency), this is illustrated in the plan view of an environment shown in FIG. 5. This may be counteracted by having the width of the field of view PIR detector divided amongst more, narrow field of view lenses for lenses that are in rows directed for capturing movement at further distances. Commonly in practice, the IR radiation from a human is not normally only detected by a lens from just one row. Nonetheless, further objects moving at the same speed as closer objects will still tend to result in longer separation in the signal peaks (i.e. a lower frequency signal) than closer objects.

The Fresnel lenses are typically arranged in rows, wherein a greater number of Fresnel lenses are provided in the rows at the top than at the bottom, and the lenses at the top are configured to capture IR radiation from entities further away and the lenses at the bottom are configured for capturing IR radiation from entities closer to, and more beneath, the PIR motion detector 210. This is illustrated in the side view of an environment shown in FIG. 6. In FIG. 6, person A and B are both lying on the floor, and person A is closer to the PIR motion detector 210 than person B.

FIG. 7 illustrates how an upper row of lenses may detect motion of a person who is lying down in an elevated position (e.g. in bed) whereas a lower row of lenses may detect motion of a person who is lying on the floor.

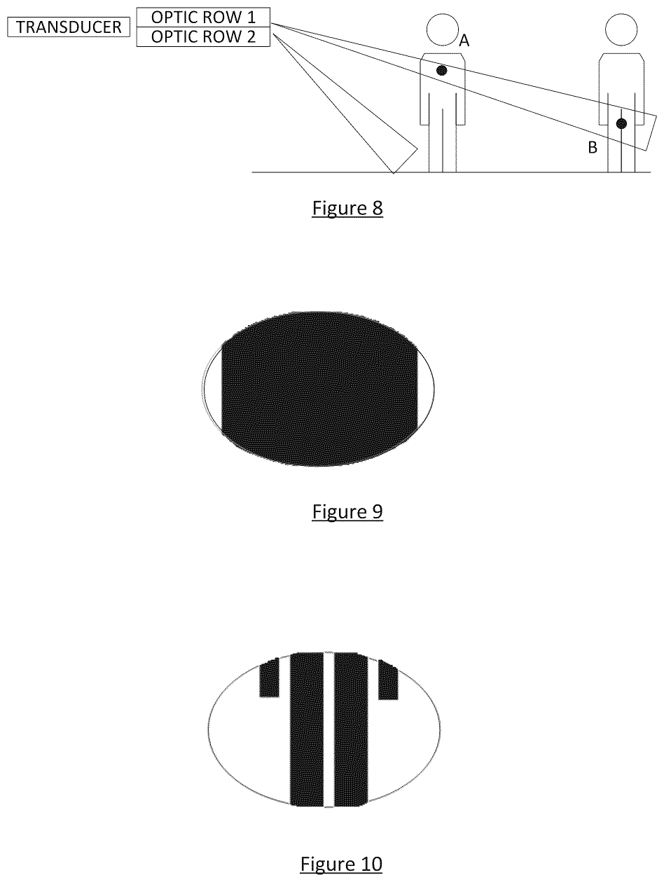

FIG. 8 illustrates a side view of an environment comprising person A and B who are both positioned sufficiently far away from the PIR motion detector 210 such that an upper row of lenses may detect motion of both people. Person A is closer to the PIR motion detector 210 than person B.

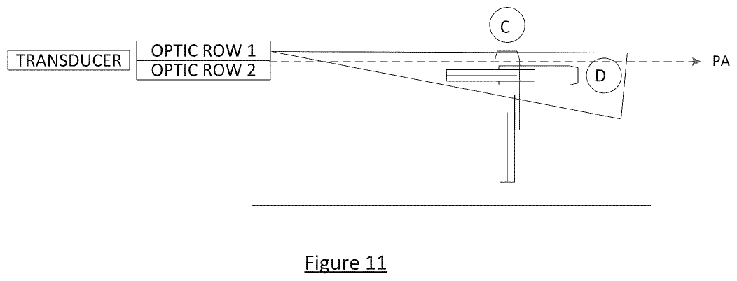

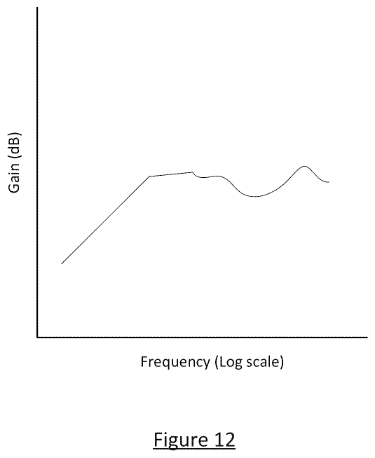

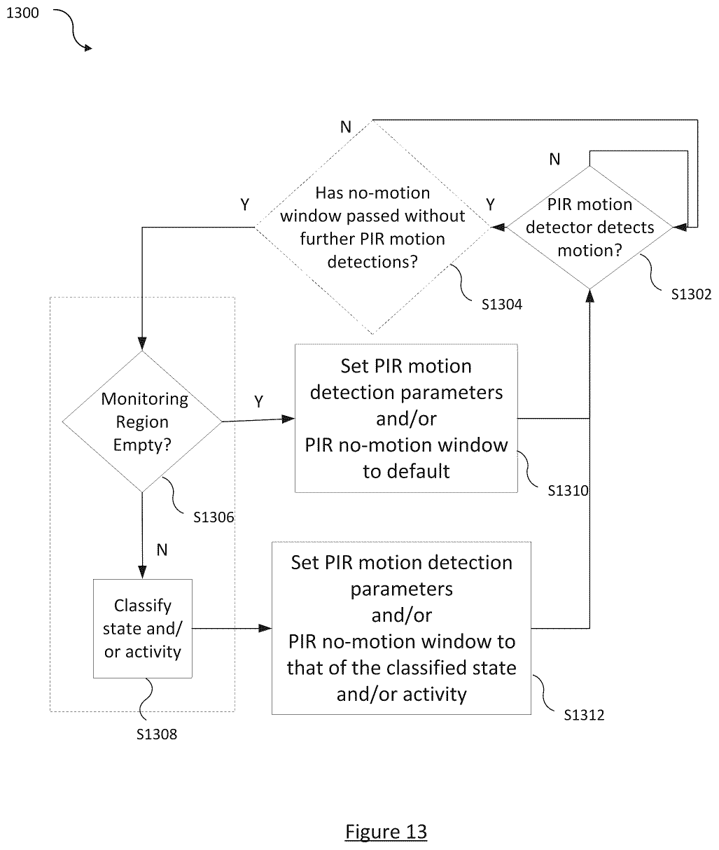

FIG. 9 illustrates the cross section of the field of view of an upper lens with person A in the field of view, whereas FIG. 10 illustrates the cross section of the field of view of an upper lens with person B in the field of view. From FIGS. 9 and 10 it can be seen that by being further away from the PIR motion detector 210, a smaller percentage of the field of view of a lens is taken up by person B than by person A. Thus, movements by person A may result in larger amplitude signals from the transducer stage than may result from movements by person B.

FIG. 11 illustrates a side view of an environment comprising a person C who is positioned perpendicular to the principal axis of the fields of view from the lenses (e.g. by standing up) and a person D who is positioned parallel to the principal axis (e.g. by lying down). It will be appreciated that a smaller percentage of the field of view of a lens is taken up by person D than by person C. For this reason for a person in a state of lying on the floor (in a position consistent with a fall, or being in an elevated lying position such as in a bed) small movements by the person may be less likely to be detected.

The PIR motion detector 210 requires a relatively low amount of power to operate compared to the active reflected wave detector 206. However, the active reflected wave detector 206 can be capable of different types of detection to the PIR motion detector 210, for example being able to determine presence of the entity irrespective of whether the entity is moving location and/or to determine distance and/or bearing to the detected entity and may optionally thereby determine direction of travel and/or velocity of the detected entity. The distance and/or bearing may be used to determine the entity's location relative to a region of interest. In contrast, the PIR motion detector 210 is generally capable of determining whether or not there is motion, such as motion of a human, but cannot determine the position of an entity. Having the PIR motion detector 210 active and capable of detecting motion but the active reflected wave detector 206 by default in the low power, e.g. inactive, state until motion is detected by the PIR motion detector 210 can beneficially result in the active reflected wave detector 206 being active and capable of detecting the entity only when required. This arrangement allows the different measurements, such as range, position, direction of travel and/or velocity of travel to be determined without excessive drain on power, which is particularly important in battery powered devices.

Whilst FIG. 4 illustrates the PIR motion detector 210 comprises the processing stage 55, one or more stages of the processing stage 55 may optionally be implemented by the CPU 202. Thus, the CPU 202 or a part thereof may form part of a PIR motion detector as described herein.

Likewise, whilst FIG. 4 illustrates the active reflected wave detector 206 as being separate distinct from the CPU 202. Thus, the CPU 202 or a part thereof may form part of an active reflected wave detector as described herein.

We now refer to embodiments of the present disclosure in which the CPU 202 performs a computer implemented method of controlling the monitoring of an environment.

In embodiments of the present disclosure, the CPU 202 controls the active reflected wave detector 206 to measure wave reflections from the environment to receive measured wave reflection data that is obtained by the active reflected wave detector as part of a reflective wave measurement operation.

The CPU 202 determines information about a person or an environment using the received measured wave reflection data (an output of the reflective wave measurement operation performed by the active reflective wave detector 206).

As will be explained in more detail below, the CPU 202 may attempt to identify a state of a person and/or an activity being performed by a person using the received measured wave reflection data. In this example, when a person is present in the region of the environment monitored by the active reflective wave detector 206, the information about a person or an environment may comprise the state and/or activity of the person.

In the context of the present disclosure, the state (or activity) of the person determined by the CPU 202 may be a characterization of the person based on a momentary assessment or over relatively short a timeframe (e.g. 1 minute or less, or more preferably, 45 seconds or less, or yet more preferably 30 seconds or less), which may have a duration that depends on the state being characterized. In one example, the state may define whether the person is in a fall state or a non-fall state. For example, the state or activity may be determined using a trained classifier. The classifier may have been trained with one or more training data sets which includes measured wave reflection data (and/or parameters extracted therefrom) and a corresponding definition of which output state the reflective wave measurements correspond to. The classifier may be operated on the device (e.g. by the CPU) in some embodiments, or remotely from device 102 by transmitting measured wave reflection data (and/or parameters extracted therefrom) to the remote device and receiving a classification result from the remote device, in other embodiments.

The parameters may include one or more of: (i) a height metric associated with at least one reflection; (ii) a velocity associated with the person using the measurements of reflections; and (iii) a spatial distribution characterization of the measurements (e.g. one or more of a horizontal spatial distribution (e.g. a variance or equivalently a standard deviation), a vertical spatial distribution and a ratio therebetween. Additionally, RCS estimates may be used to aid in assessing whether the object being classified is in fact a human. Analysis of the wave reflections to determine whether the object is likely to be human may be performed before or after the classification, but in other embodiments it may be performed as part of the classification. Thus, the classifier may additionally receive the following parameters: (iv) a sum of RCS estimates, and in some embodiments (v) a distribution (e.g., variance or equivalently standard deviation) of RCS estimates. For example, the received parameters may be: 1. an average height (e.g. median z value); 2. a standard deviation of RCS estimates; 3. A sum of RCS estimates; and 4. a standard deviation of height (z) values.

The trained classifier may use corresponding received the parameters, during use, to perform a classification in use. In some embodiments the classification performed by the CPU 202 may use a plurality of velocity magnitude measurements of the person corresponding to different times, each of these velocity magnitude measurements determined using the reflections associated with the person conveyed in the output of the active reflected wave detector.

The classification may be performed by the trained classifier receiving measured wave reflection data from the active reflective wave detector 206 (and/or parameters extracted therefrom) from a set of sequential frames over a period of time and classifying the state or activity of the person based on the set of sequential frames. For example, the classifier may classify the person as being in a fall position based on the person's fall/non-fall positions for the respective frames. Multiple frames (e.g. 10 frames) may be used to determine whether there are more fall or non-fall results to improve the accuracy of the determination (the result which occurs more is the selected result). The classification may be based on their position (e.g. in a location in respect to the floor and in a configuration which are consistent or inconsistent with having fallen) and/or their kinematics (e.g. whether they have a velocity that is consistent or inconsistent with them having fallen, or having fallen and possibly being immobile). In some embodiments, the classification performed by the CPU 202 may provide further detail on a non-fall state for example, the CPU 202 may be able to classify the person as being in a state from one or more of: a free-standing state (e.g. they are walking); a safe supported state which may be a reclined safe supported state whereby they are likely to be safely resting (e.g. a state in which they are in an elevated lying down position, or in some embodiments this may additionally encompass being in a sitting position on an item of furniture); and a standing safe supported state (e.g. they are standing and leaning on a wall). In other embodiments the non-fall states may be grouped differently. The timeframe used to classify a person as being in a fall state need not be the same timeframe used to determine the person is in a state that is not a fall state.

Further details of an exemplary method for implementing such a classifier may be found in International Patent Application no. PCT/IL2020/051345, filed 29 Dec. 2020, the contents of which are incorporated herein in their entirety.

In the context of the present disclosure, an activity of a person may refer to what action the person is involved in (e.g. what they are engaged in or what they are doing) over time (i.e. the time taken to collect the frame(s) for performing the classification). Examples include watching TV, eating, conversing, walking and playing an instrument. It will be appreciated that some activities (e.g. walking) could be equally categorized as being states.

As used herein, “determining a state or activity” may comprise identifying only a state, only an activity or both a state and an activity. An example of identifying both a state and an activity may be that a person is respectively both sitting and, at the same time, eating.

Additionally or alternatively, the CPU 202 may attempt to identify a position of a person relative to the PIR motion detector 210 using the received measured wave reflection data. In this example, if a person present in the region of the environment monitored by the active reflective wave detector 206, the information about a person or an environment may comprise the position of the person relative to the PIR motion detector 210.

In some scenarios, the CPU 202 may determine, using the received measured wave reflection data, that there is no person present in the region of the environment monitored by the active reflective wave detector 206. In this example, the information about a person or an environment may indicate that there is no person present in the region of the environment monitored by the active reflective wave detector 206.

In embodiments of the present disclosure, the CPU 202 adapts one or more parameters of a triggering module based on the information referred to above.

In particular, the CPU 202 determines a scenario relating to a person or an environment, based on the information referred to above, and sets the one or more parameters of the triggering module based on the determined scenario. The scenario may define whether the environment is vacant of people or has a single person or plurality of people present with respect to the region monitored by the active reflective wave detector 206. In scenarios in which a person is present in the region the scenario may be defined, or further defined, by the person's state or activity performed by the person and/or a position of the person relative to the PIR motion detector. The CPU 202 may determine a scenario based on the information referred to above, and set the one or more parameters of the triggering module to values corresponding to the determined scenario. Where a scenario is identified in which a single person is present in the environment, one or more parameters of the triggering module may be assigned according to the state of, or activity performed by the person, as described herein. Where multiple people are present and are all in the same state or performing the same activity, the one or more parameters of the triggering module may, in one embodiment, be assigned according to common state of, or activity performed by the person, or may, in another embodiment, be assigned according to a scenario for which the one or more parameters would be set such that the PIR motion detector would have a relatively low sensitivity, e.g. the one or more parameters may be set to the same values as for when the room is vacant. Where multiple people are present but are in different states or performing the different activities, the one or more parameters of the triggering module may, in one embodiment, be assigned to whichever of the peoples states or activities would correspond to setting the PIR motion detector to the most insensitive, or, in another embodiment, be assigned according to a scenario for which the one or more parameters would be set such that the PIR motion detector would have a relatively low sensitivity, e.g. the one or more parameters may be set to the same values as for when the room is vacant. Having a relatively low PIR sensitivity while multiple people are present may have an advantage of causing relatively few triggering of the active reflected wave detector, and thereby save power, which may be justified on the basis that while multiple people are present there is less need (at least as far as safety is concerned) to monitor the people than when only a single person is present. The number of people present in the environment may readily be determined from the measured wave reflection data using any known technique in the art.

Where the specification refers to information or scenarios in relation to a person ‘or’ an environment it will be understood, that conjunction ‘or’ may mean “at least one of”, or “one or both of”.

Each of a plurality of different scenarios may have a respective set of values assigned to one or more parameters of the triggering module, e.g. in a look up table which may be stored in memory 204.

The triggering module is used for starting a later operation (reflective wave measurement operation) of the active reflected wave detector 206 to determine further information about the person or the environment. This later operation is started based on an output of the PIR motion detector 210.

The active reflected wave detector 206 may be triggered by the CPU 202 responsive to detection of motion by the PIR motion detector 210, e.g. switchable from a first state to at least a second state. The first state may comprise one or more or each of: a deactivated state, an off state, a lower powered state and/or a non-sensing state. The second state may comprise one or more or each of: the activated state, an on state, a higher powered state than the first state and/or a sensing state. The CPU 202 may utilise a PIR no-motion detection window for the triggering of the active reflected wave detector 206. That is, the active reflected wave detector 206 may be triggered by the CPU 202 responsive to expiry of the PIR no-motion detection window, which commences in response to the PIR motion detector detecting motion, and is restarted in response to any further motion detected by the PIR motion detector 210.

In some embodiments, the triggering module corresponds to the processing stage 55. That is, the CPU 202 adapts a parameter of one or more of the stages in the processing stage 55.

Additionally or alternatively, the triggering module corresponds to functionality of the CPU 202 which sets and monitors the PIR no-motion detection window. That is, the CPU 202 may adapt a length of the PIR no-motion detection window.

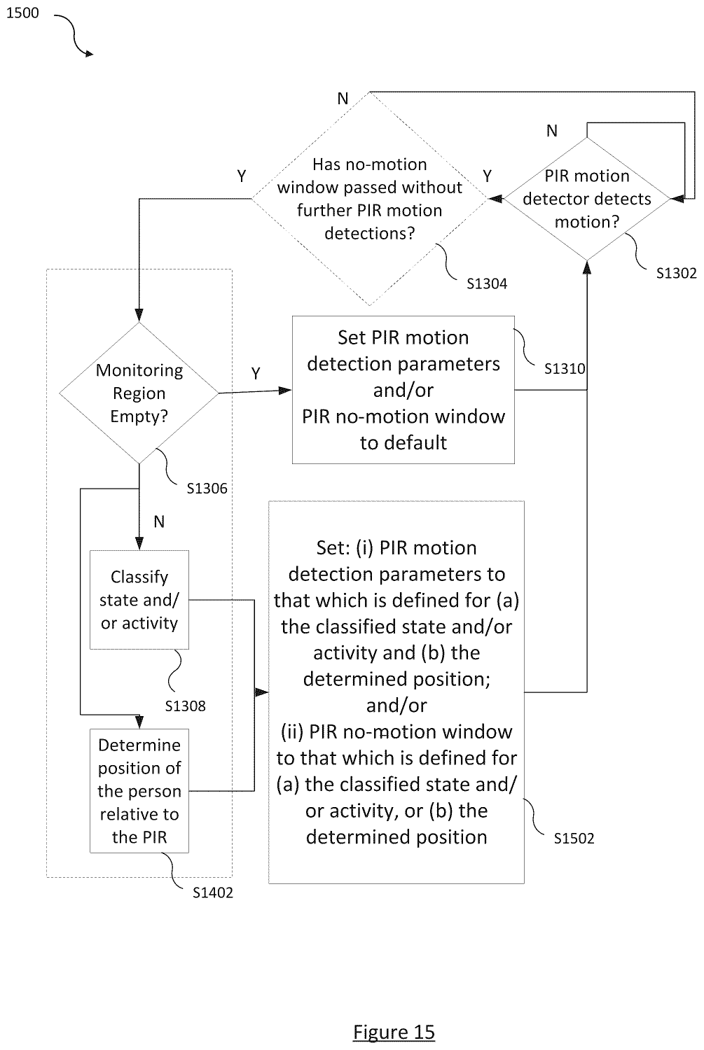

FIG. 13 illustrates a process 1300 performed by the CPU 202 for controlling the monitoring of a person or an environment.

At step S1302, the CPU 202 determines whether the PIR motion detector 210 detects motion in an environment.

In response to determining that the PIR motion detector 210 has detected motion in the environment, the process 1300 may proceed to step S1304 where the CPU 202 determines whether a PIR no-motion detection window has expired without any further motion detected by the PIR motion detector 210.

If the PIR no-motion detection window has expired without any further motion detected by the PIR motion detector 210, the CPU 202 controls the active reflected wave detector 206 to switch from the first state to the second state such that the active reflected wave detector 206 measures wave reflections from the environment. This enables the CPU 202 to determine at step S1306 whether a person is present in the region of the environment monitored by the active reflective wave detector 206 based on measured wave reflection data.

The length of the PIR no-motion detection window may be set to zero such that step S1304 is not performed. In particular, in response to determining that the PIR motion detector 210 has detected motion in the environment, the process 1300 may proceed to step S1306 without monitoring any PIR no-motion detection window.

If the CPU 202 determines at step S1306 that the region of the environment monitored by the active reflective wave detector 206 is vacant (no person is present), the process 1300 proceeds to step S1310. It will be appreciated that reference to the region of the environment monitored by the active reflective wave detector 206 being vacant means that no people are present in the region, other objects such as furniture etc. may be present in the region.

At step S1310, the CPU 202 may set a parameter of one or more of the stages in the processing stage 55 to a default value. That is, the CPU 202 may set a parameter of one or more of the gain stage 60, the comparison stage 65 and the event processing stage 70 to a respective default value. These default parameter values of the processing stage 55 may correspond to the parameters values used when a person is in a locomotory state or when a person is performing a locomotory activity. Alternatively, these default parameter values of the processing stage 55 may correspond to the parameters values used when the environment is vacant (no person present).

Additionally or alternatively, at step S1310 the CPU 202 may set the PIR no-motion detection window to a default value. The default length of the PIR no-motion detection window may be zero but preferably has non-zero value, such as a value greater than 10, 15 or 20 or 30 seconds. The default length of the PIR no-motion detection window may correspond to the length of the PIR no-motion detection window used when a person is in a locomotory state or when a person is performing a locomotory activity. Alternatively, the default length of the PIR no-motion detection window may correspond to the length of the PIR no-motion detection window used when the environment is vacant (no person present).

Referring back to step S1306, if the CPU 202 determines at step S1306 that the region of the environment monitored by the active reflective wave detector 206 is not vacant (a person is present), the process 1300 proceeds to step S1308.

At step S1308, the CPU 202 determines a state of the person and/or an activity being performed by the person using the received measured wave reflection data.

In other embodiments the order in which steps 1308 and 1306 are performed may be reversed. For example, the CPU 202 may execute an algorithm to determine a state of the person and/or an activity being performed by the person, and if no state or activity is identified, it may be concluded that the region is vacant of any people. In yet other embodiments, steps 1308 and 1306 may be performed simultaneously. For example a classifier may provide an output defining either an identified state or activity or a conclusion of a vacant region.

At step S1312, the CPU 202 sets one or more parameters of the triggering module according to the state and/or activity of the person.

At step S1312, the CPU 202 may set a parameter of one or more of the stages in the processing stage 55 to a value associated with the state and/or activity of the person. That is, the CPU 202 may set a parameter of one or more of the gain stage 60, the comparison stage 65 and the event processing stage 70 to a value tailored for the state and/or activity of the person.

Additionally or alternatively, at step S1312 the CPU 202 may set the PIR no-motion detection window to a value associated with the state and/or activity of the person. The length of the PIR no-motion detection window for a given classified state and/or activity may be zero but preferably has a non-zero value, such as a value greater than 10, 15 or 20 or 30 seconds.

After step S1310 or S1312 has been performed the process 1300 loops back to step S1302.

At step S1310 or S1312 the CPU 202 may set a gain parameter defining a gain provided by the gain stage 60 of the PIR motion detector 210. The gain parameter may define the level of gain applied to all frequencies of the electrical signal from the transducer stage 50. The gain may additionally or alternatively be adjusted differently at different frequencies, for example a signal from the transducer stage 50 may be subjected to a higher or lower gain at some frequencies compared with other frequencies, thereby having an effect on the profile of the frequency response of the gain stage 60. Thus the frequency response of the gain stage 60 may be modified to change the relative impact of different frequencies and/or the gain may be increased or decreased evenly across all frequencies.

For example, a person in a state of lying on the floor (in position consistent with a fall, or being in an elevated lying position such as in a bed) may result in a lower strength IR signal from the transducer stage 50 than if they were they standing. This may support using a larger gain in the gain stage for such lying configurations.

Additionally, when the person is lying on the floor (e.g. they have fallen) the type of movement expected is relatively small and slow movements, and the slowness of the movements translates to low frequency signals. It is desirable to be able detect such scenarios in order to know if they are moving at all or not. Therefore detection of motion in such scenarios may be aided by having a relatively high gain of low frequency signals. To still enable capturing of faster motions a normal gain may be maintained for high frequency signals.

What is considered normal and relatively high or low may be in comparison with how the PIR motion detector is configured for when the person is in a locomotory state and/or when the monitored region is determined to be vacant of people.

It will be appreciated that the “low” and “high” frequencies referred to herein are relative terms, and they can be determined empirically per lens configuration. The pyroelectric sensor of the transducer stage 50 may comprise at least one pair of pyroelectric elements. Optionally, each pyroelectric sensor may have a frequency range of 0.1 Hz to 20 Hz, 0.1 Hz to 10 Hz, 0.1 Hz to 6 Hz, 0.3 Hz to 10 Hz, or 0.3 Hz to 6 Hz. Reference to “low” frequency signals may refer to frequencies in the lower part of the frequency range of the pyroelectric sensor. For example, reference to “low” frequencies may refer to frequencies below a first pre-defined value. The first predefined value may for example be within a range between 0.5 Hz to 2 Hz, or 0.8 Hz to 1.2 Hz, e.g. approximately 1 Hz. Reference to “low” frequencies may refer to frequencies less than or equal to 1 Hz. Reference to “high” frequency signals may refer to frequencies in the upper part of the frequency range of the pyroelectric sensor. For example, reference to “high” frequencies may refer to frequencies above a first pre-second defined value. The second predefined value may for example be within a range between 3 Hz to 6 Hz, 3.5 to 5 Hz, e.g. approximately 4 Hz, or 5 Hz. Reference to “high” frequencies may refer to frequencies less than or equal to 4 Hz. Optionally reducing or increasing the gain (or respectively increasing or decreasing a comparator threshold) of low or high frequencies may comprise or consist or performing the reduction or increase for one or more bands band within what may be classed as low or high frequencies. For example, the gain corresponding to one or more bands of low frequencies or one or more bands of high frequencies may be altered. However, what may be deemed as appropriate low frequencies and high frequencies for the purpose of the disclosure herein may be determined empirically for the particular hardware employed and/or for the scenarios sought to be distinguished, and need not be limited to the example scenarios or example first and second predefined values referred to herein.

In another example, if it is determined at step S1306 that the region of the environment monitored by the active reflective wave detector 206 is vacant (no person is present), the CPU 202 may set the gain parameter (lower the gain) for high frequencies. or at least high frequencies, such that the PIR motion detector 210 is less sensitive to motion, or less sensitive to motion corresponding to high frequencies, than when the gain parameter is set for a scenario in which the person is in a locomotory state or engaged in a locomotory activity, so as to minimize the risk of false alarms from other (non-human) objects that may move. One such cause of false alarms may be if the PIR motion detector 210 is positioned in an environment such that one or more trees are in its field of view. By using a lower gain at high frequencies when no person is present in the environment than when the environment is occupied, false motion detections caused by leaves swaying in the wind may be prevented or reduced. As will be appreciated the same decreasing the gain may be considered as equivalent to increasing the threshold(s) of the comparison stage 65. Where gain is decreased for certain frequencies, this may be considered equivalent to increasing threshold(s) used for those frequencies.

At step S1310 or S1312 the CPU 202 may set at least one frequency response parameter defining a frequency response profile of the gain stage 60 of the PIR motion detector 210. The at least one frequency response parameter may define the frequency range of the gain stage 60. The at least one frequency response parameter may also define how some frequencies may have different gains to other frequencies, e.g. to emphasize high or low frequencies within the frequency range.

For example, if a person is in one postural state and it is desirable to check when they move to another, triggering the active reflective wave detector 206 to classify the person's state every time they do a slow movement (as is common for small movements) would waster battery power. Therefore a high pass filter (so resulting in very small/negligible low frequency gain), or a high frequency boost compared with low frequencies, may be beneficial in order detect a change in motion that may correspond with them changing a postural state (e.g. standing up) and or state of locomotion (especially walking), but not to detect small, slow motions, e.g. by the arms or hands (e.g. page turning), sleeping movements.

In another example, if it is determined at step S1306 that the region of the environment monitored by the active reflective wave detector 206 is vacant (no person is present), the CPU 202 may set the at least one frequency response parameter, so as to minimize the risk of false alarms from other (non-human) objects that may move (e.g. a curtain moving, or leaves swaying, as a result of breeze). This may be achieved for example by lowering a high-frequency cut-off frequency of a low pass filter and/or by reducing gain at high frequencies (e.g. at least some frequencies above the second predefined value), which may be relative to low frequencies or relative to frequencies below the second predefined value. In another example, the sensitivity may be reduced for all frequencies by reducing the gain (or equivalently increasing the thresholds of the comparison stage 65) for all frequencies. An appropriate level of gain reduction may be determined empirically (e.g. 5%, 10%, 20%. 30%, 40% or 50% etc. as non-limiting examples). Regardless of whether making the change to some or all frequencies, the change may be relative to when the person is in a locomotory state or engaged in a locomotory activity. Additionally, or alternatively, the value for N may be set to a higher value than when the person is in a locomotory state or engaged in a locomotory activity. In some embodiments, N may be set to 3 or 4 or more when no person is present. This may contrast to N being set to 2 or 3 when the person is in a locomotory state or engaged in a locomotory activity.

At step S1310 or S1312 the CPU 202 may set at least one threshold parameter, the at least one threshold parameter defining at least one threshold used in the comparison stage 65 of the PIR motion detector 210. The at least one parameter is set based on the outcome of the previous step, e.g. based on a determination that the monitoring region is vacant or based on the determined state or activity. However, if the outcome of step S1306 and S1308 is the same as the last time through the processing loop, the at least one parameter may remain unchanged, thereby skipping the relevant step S1310 or S1312.

As noted above, the comparison stage 65 may utilise a single threshold. This may be the case, for example, where the output of the gain stage 60 is an absolute value. In these embodiments, the CPU 202 may set a threshold parameter defining a value of the single threshold. In other embodiments, a positive and negative thresholds may respectively be used to compare the output of the gain stage 60. In these embodiments, the CPU 202 may set a threshold parameter defining a value for the positive threshold and a threshold parameter defining a value for the negative threshold. As will be appreciated there is an inverse relationship between the gain and threshold, e.g. increasing the gain has an equivalent effect to decreasing the threshold. It will also be appreciated that different thresholds may be used for different frequency ranges, thereby having an analogous effect to changing the frequency response profile of the gain stage 60 to determine the frequency response profile of the PIR motion detector 210.

For example, to make the PIR motion detector 210 highly sensitive to slow types of movements the CPU 202 may decrease the value of a threshold parameter defining a value of the threshold(s) corresponding to at least low frequencies. Conversely, to make the PIR motion detector 210 less sensitive to slow types of movements the CPU 202 may increase the value of the threshold(s) corresponding to at least low frequencies.

At step S1310 or S1312 the CPU 202 may set a parameter defining a minimum number of times, N, a threshold used in the comparison stage 60 of the PIR motion detector must be exceeded in order for motion to be detected. In particular, for the event processing stage 70, the CPU uses a counter, n, to count the number of times the output of the gain stage 60 crosses a threshold from the comparison stage. Motion is detected only if, and when, n reaches N. The counter n may be reset to zero each time motion is detected and the process has moved on from step 1302 and/or the next time the motion detection step S1302 commences (e.g. at the conclusion of the next iteration of step S1310 or S1312).

The value for N can have a bearing on spatial sensitivity because if the value of N is lower it means the person has to move further in the environment in order for n to reach N.

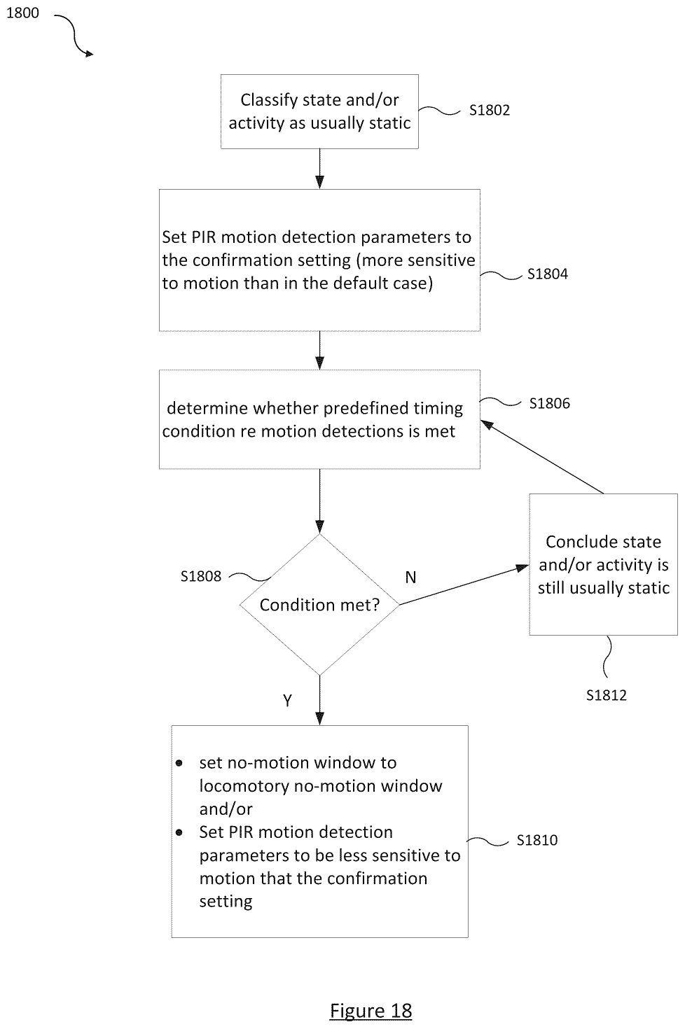

To make the PIR motion detector 210 highly sensitive to small movements the CPU 202 may set the value of the parameter N to 1. Such a setting for N may for example be used if the person is determined to be in a usually static state and/or engaged in a usually static activity and the CPU 202 is, in response, configured for monitoring for continuance of that that state of activity, for example as described below in relation to FIG. 18. To make the PIR motion detector 210 less sensitive to small movements (e.g. in response to the region being determined to be vacant or the person being identified as being in a locomotory state or performing a locomotory activity) the CPU 202 may set the value of the parameter N to be larger, e.g. 2 or 3, so as to provide better immunity to noise.

Where N is greater than 1, the event processing stage 70 also take into account time, otherwise, single crosses (of the threshold) separated by a long time could be counted as multiple events. Where N>1, the event processing stage 70 may require that N is reached within a predefined time period. It may be further qualified by the event processing stage 70 that the frequency with which crossings occur is within the frequency range of the PIR motion detector 210.

As will be understood by a person skilled in the art the transducer in the transducer stage 50 of a PIR motion detector produces an output that includes signal peaks that swings between positive and negative peaks as the person moves across the field of view of PIR motion detector, with the different peaks occurring at different locations of the person. A single threshold may be used in comparison with an absolute value of the signal or where the signal is otherwise made to be unipolar, whereas positive and negative thresholds may be used where the signal is bipolar. Thus, whilst we refer above to a single threshold being used by the event processing stage 70 there could be two thresholds, a positive threshold and a negative threshold. Each time the signal passes beyond any of these thresholds may increment the counter n.

FIG. 14 illustrates a process 1400 performed by the CPU 202 for controlling monitoring of a person or an environment.

In a variant of the process 1300 described above, in the process 1400 if the CPU 202 determines at step S1306 that the region of the environment monitored by the active reflective wave detector 206 is not vacant (a person is present), the process 1400 additionally proceeds to step S1402. As in process 1300, in process 1400 if the monitoring region is vacant the process proceeds to step S1310.

At step S1402 the CPU 202 determines the position of the person relative to the PIR motion detector 210 using the received measured wave reflection data.

The determined position of the person relative to the PIR motion detector may comprise one or more of: an orientation of the person with respect to a principal axis of at least one lens of the PIR motion detector 210; a distance of the person from the PIR motion detector; a spatial distribution of the person; and a height of the person above a floor of the environment.

At step S1404 the CPU 202 sets a parameter of one or more of the stages in the processing stage 55 to a value associated with the determined position of the person. That is, the CPU 202 may set any of the parameters referred to above (e.g. the gain parameter, threshold parameter, at least one frequency response parameter and/or parameter N) to a value which is defined for the determined position of the person.

In the process 1400, in response to the CPU 202 determining a state of the person and/or an activity being performed by the person using the received measured wave reflection data, the process 1400 may proceed to step S1412.

At step S1412, the CPU 202 may set the PIR no-motion detection window to a value associated with the state and/or activity of the person.

FIG. 15 illustrates a process 1500 performed by the CPU 202 for controlling monitoring of a person or an environment.

In a variant of the process 1400 described above, once the CPU 202 has determined, at step S1308, a state of the person and/or an activity being performed by the person using the received measured wave reflection data; and has determined, at step S1402, the position of the person relative to the PIR motion detector 210 using the received measured wave reflection data, the process 1500 proceeds to step S1502.

At step S1502, the CPU 202 may set a parameter of one or more of the stages in the processing stage 55 to a value associated with (a) the state and/or activity of the person; and/or (b) the determined position of the person. That is, the CPU 202 may set any of the parameters referred to above (e.g. the gain parameter, threshold parameter, at least one frequency response parameter and/or parameter N) to a value which is defined for (a) the state and/or activity of the person; and/or (b) the determined position of the person.

Additionally or alternatively, at step S1502 the CPU 202 may set the PIR no-motion detection window to a value associated with (a) the state and/or activity of the person; and/or (b) the determined position of the person.

In any of the processes referred to above, the CPU 202 may determine that the person is in a locomotory state or performing a locomotory activity using the received measured wave reflection data.

We refer herein to “locomotory” as meaning that the person moves their location in the environment whilst in the locomotory state or performing the locomotory activity. For example, the person may be in a standing locomotory state or activity (e.g. walking, running) or a non-standing locomotory states or activity (e.g. crawling).

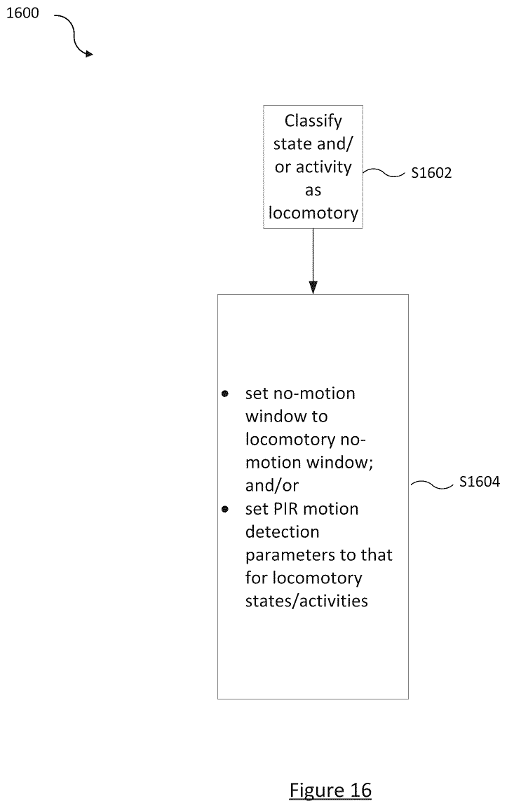

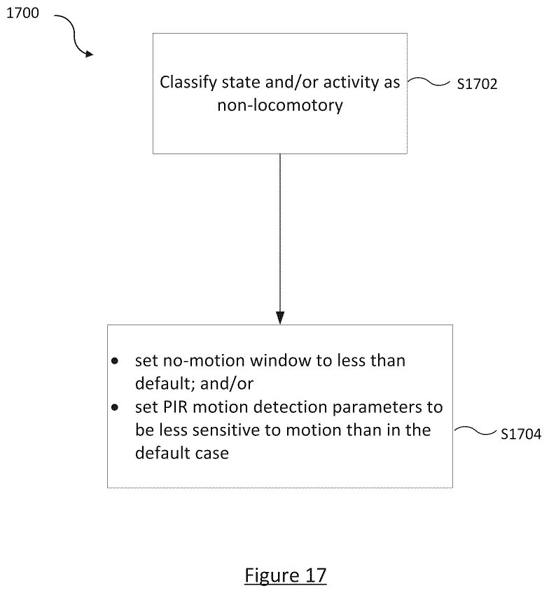

FIG. 16 illustrates a process 1600 performed by the CPU 202 for setting one or more parameters of a triggering module of the device according to the state and/or activity of the person being locomotory.

At step S1602, the CPU 202 determines that the person is in a locomotory state or performing a locomotory activity using the received measured wave reflection data.

At S1604, the CPU 202 may set a parameter of one or more of the stages in the processing stage 55 to a value associated with a locomotory state or a locomotory activity. That is, the CPU 202 may set a parameter of one or more of the gain stage 60, the comparison stage 65 and the event processing stage 70 to a value predetermined for locomotory states or activities. In one example, the parameter value(s) associated with a locomotory state or a locomotory activity are the same as the default parameter value(s) set at step S1310.

Alternatively, or additionally, at step S1604 the CPU 202 may set the PIR no-motion detection window to a value associated with a locomotory state or a locomotory activity. In one example, the length of the PIR no-motion detection window for a locomotory state or a locomotory activity is the same as the default length of the PIR no-motion detection window set at step S1310.

It will be appreciated that there need not be a classification of “locomotory” assigned to the state of the person or the activity being performed by the person. It could just be that is a person is identified as walking then the locomotory values are applied to the one or more parameters of the triggering module.

In any of the processes referred to above, the CPU 202 may determine that the person is in a non-locomotory state or performing a non-locomotory activity using the received measured wave reflection data.

We refer herein to “non-locomotory” as meaning that the person is not moving their location in the environment whilst in the locomotory state or performing the locomotory activity. For example the person may be sitting at a table eating, or sitting watching television.

In one embodiment, when the person in the non-locomotory state or performing the non-locomotory activity, the person is usually moving one or more body parts for which the person has conscious control of (for example the body parts may more specifically be limbs and/or their jaw). For example, they may be eating.

However, in other embodiments, when the person in the non-locomotory state or performing the non-locomotory activity, the person may be usually not moving any body parts for which the person has conscious control. For example, they may be sleeping or resting in a bed (which for the purposes herein may optionally be treated as the same as sleeping).

FIG. 17 illustrates a process 1700 performed by the CPU 202 for setting one or more parameters of a triggering module of the device according to the state and/or activity of the person being non-locomotory. This may occur, for example, as an outcome of step S1308.

At step S1702, the CPU 202 determines that the person is in a non-locomotory state or performing a non-locomotory activity using the received measured wave reflection data.

At S1704, the CPU 202 may set a parameter of one or more of the stages in the processing stage 55 to a value associated with a non-locomotory state or a non-locomotory activity. That is, the CPU 202 may set a parameter of one or more of the gain stage 60, the comparison stage 65 and the event processing stage 70 to a value predetermined for non-locomotory states or activities. This controls the PIR motion detector to be less sensitive to motion than when the one or more parameters of the triggering module are set to the default parameter value(s) set at step S1310. Alternatively, or additionally, at step S1704 the CPU 202 may set the PIR no-motion detection window to a value associated with a non-locomotory state or a non-locomotory activity.

In one example, the length of the PIR no-motion detection window for a non-locomotory state or a non-locomotory activity is less than the default length of the PIR no-motion detection window set at step S1310. The no motion detection window may for example be set to a value of less than 15 seconds, or less than 10 seconds, or less than 5 seconds. Optionally the PIR no-motion detection window may more particularly be set to zero (i.e. it may be omitted).

In any of the processes referred to above, the CPU 202 may determine that the person is in a usually static state or performing a usually static activity using the received measured wave reflection data. We refer herein to “usually static” as meaning that the person is usually not performing any movements other than basic vital life functions, e.g. brain stem controlled functions, such as, breathing, heartbeat, swallowing. Such non basic vital life function movements may include for example limb movements, including such movements occurring during sleep. In some embodiments, in the usually static state or while performing the usually static activity, the non-basic vital life function movements may occur only intermittently, one example is sleeping. Further, the usually static state or activity may be more strongly skewed to the person towards performing no non-basic vital life function movements, for example with a ratio of at least 10:1 of time spent with only basic vital life function movements to time spent with non-basic vital life function movements.

In response to determining that the person is in a usually static state or performing a usually static activity, the CPU 202 may set a parameter of one or more of the stages in the processing stage 55 to a value associated with a usually static state or a usually static activity. That is, the CPU 202 may set a parameter of one or more of the gain stage 60, the comparison stage 65 and the event processing stage 70 to a value predetermined for usually static states or activities.

This controls the PIR motion detector to be less sensitive to motion than when the one or more parameters of the triggering module are set to the default parameter value(s) set at step S1310.

Additionally or alternatively, in response to determining that the person is in a usually static state or performing a usually static activity, the CPU 202 may set the PIR no-motion detection window to a value associated with a usually static state or a usually static activity.

In one example, the length of the PIR no-motion detection window for a usually static state or a usually static activity is less than the default length of the PIR no-motion detection window set at step S1310. In one example, the length of the PIR no-motion detection window for a usually static state or a usually static activity may be less than 15 seconds, or less than 10 seconds, or less than 5 seconds, or in some embodiments set to zero.

FIG. 18 illustrates a process 1800 performed by the CPU 202 for confirming continuance of a state of a person and/or an activity being performed by a person.

At step S1802, the CPU 202 determines that the person is in a usually static state or performing a usually static activity using the received measured wave reflection data.

The CPU 202 may set the length of PIR no-motion detection window to the default length of the PIR no-motion detection window.

At step S1804, the CPU 202 sets a parameter of one or more of the stages in the processing stage 55 to a value associated with a confirmation setting. That is, the CPU 202 may set a parameter of one or more of the gain stage 60, the comparison stage 65 and the event processing stage 70 to a value associated with the confirmation setting.

This controls the PIR motion detector to be more sensitive to motion than when the one or more parameters of the processing stage 55 are set to the default parameter value(s) set at step S1310.

At step S1806 and S1808, the CPU 202 determines whether a predefined condition has been met. The predefined condition relates to motion detections detected by the PIR motion detector 210. The predefined condition may comprise that a number of motion detections detected by the PIR motion detector within a predetermined time period exceeds a first threshold. Alternatively or additionally, the predefined condition may comprise that a time between successive motion detections detected by the PIR motion detector is below a second threshold.

For example, in the case of confirming continuance of sleeping, the first threshold may be equal to 2. The predetermined time period may be for example be 5 minutes. The second threshold may be 30 seconds. Thus, the process may proceed to step S1810 only if motion is detected in either one of: more than twice in a 5 minute window, or more than twice within a 30 seconds window. Otherwise, it is assumed at step S1812 that the person is still sleeping, and the process returns to step S1806 to continue to wait for further motion detections and determine whether, as they occur, the predefined timing condition is met at step S1808.

On the other hand, if the timing condition is met, it is assumed that the person may have left their sleeping location (e.g. their bed). In response, the CPU 202 may thereby act on an assumption that the person has switched to a locomotory state and/or is engaged in a locomotory activity, e.g. by setting one or more parameters of the triggering module according to the person being in a locomotory state and/or is engaged in a locomotory activity.

For example, at step S1810 the CPU 202 may set one or more parameters of the triggering module to control the PIR motion detector 210 to be less sensitive to motion than when the one or more parameters of the triggering module are set to the confirmation setting values (which at step S1804 had been made more motion sensitive than the setting values for a locomotory state/activity).

The CPU 202 may set one or more parameters of the triggering module to control the PIR motion detector 210 for example by setting a parameter of one or more of the stages in the processing stage 55 to a value associated with a locomotory state or a locomotory activity. That is, the CPU 202 may set a parameter of one or more of the gain stage 60, the comparison stage 65 and the event processing stage 70 to a value predetermined for locomotory states or activities.

As noted above, in one example the parameter value(s) associated with a locomotory state or a locomotory activity are the same as the default parameter value(s) set at step S1310.

Alternatively, or additionally, at step S1810 the CPU 202 may set the PIR no-motion detection window to a value associated with a locomotory state or a locomotory activity.

As noted above, in one example the length of the PIR no-motion detection window for a locomotory state or a locomotory activity is the same as the default length of the PIR no-motion detection window set at step S1310.

After step S1810, the process 1800 may then proceed to step S1302, or in another embodiment may proceed to step S1306 or step S1308 (skipping steps S1302 and S1304).

In a variation of process 1800, if the condition at step S1808 is met, then rather than step S1808 being automatically followed by step S1810, step S1808 may instead to proceed to step 1306 or step 1308. Thus the CPU 202 may thereby confirm that the person has in fact left the their prior state/activity, that is that they are indeed no longer in the usually static state or performed in the usually static activity, before changing any parameters of the triggering module to correspond to the newly determined state/activity.

Referring back to steps S1806 and S1808, if the predefined condition has not been met, the process 1800 proceeds to step S1812 where the CPU 202 concludes that the person is still in a usually static state or still performing a usually static activity (i.e. the CPU 202 confirms continuance of the usually static state or usually static activity).

It is to be understood that states or activities in which a person is said herein to be usually in a certain condition (e.g. usually static or usually moving), is with reference to over the course of the a person being in the state or performing activity, e.g. over the course of their sleep, over the course of the person eating (optionally defined in reference to a part of a meal after which they take a temporary break from eating, or alternatively in reference to an entire meal or meal sitting), over the course of them sitting, over the course of them walking, etc. What is usual for the state or activity may be defined for that person based on their history or during a set-up/calibration process, e.g. by measuring and recording the person during one or more occurrences of that state or activity for that person; or may be defined in relation to a reference person, for example as determined by an average for a population or a demographic, which optionally may be selected to correspond to that person, for example based on any correlated parameters. The correlated parameters may for example include age, gender, physiological measurements (e.g. resting heart rate and/or blood pressure, body mass index, etc.). What is said herein to be ‘usual’ may be defined in any number of ways. In some embodiments, usual may be with reference to an amount falling between a predefined range of percentages of time, for example between 50% and 100% of the time, between 60% and 100% of the time, or between 75% and 100% of the time, in some embodiments. The reference to usual may be in reference to what is expected to happen each time the state or activities occurs, for an average duration of the state or activity. As an example, for a state or activity for which a person is usually in condition X, then when a person is in the state or performing the activity for a duration Y, the person is expected to be in condition X for a majority of Y. Thus, in ‘usually’ may mean ‘mostly’.

Generally, any of the functions described herein can be implemented using software, firmware, hardware (e.g., fixed logic circuitry), or a combination of these implementations. The terms “module”, “functionality”, and “stage” as used herein generally represent software, firmware, hardware, or a combination thereof. In the case of a software implementation, the module, functionality, or stage represents program code that performs specified tasks when executed on a processor (e.g. CPU or CPUs). The program code can be stored in one or more computer readable memory devices. The features of the techniques described below are platform-independent, meaning that the techniques may be implemented on a variety of commercial computing platforms having a variety of processors.

Steps/elements referred to herein by like reference numerals are intended to refer to like steps/elements.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. In addition, any priority document(s) of this application is/are hereby incorporated herein by reference in its/their entirety.

1. A computer implemented method of controlling monitoring of a person or an environment, the computer implemented method comprising:
determining information about a person or an environment using an output of an operation of an active reflective wave detector configured to measure wave reflections from an environment; and
based on the information, adapting one or more parameters of a triggering module used for starting a later operation of the active reflected wave detector to determine further information about the person or the environment, the later operation being started based on an output of a PIR motion detector that is arranged to monitor motion in the environment, the output indicating that a motion has occurred after said operation of an active reflective wave detector.

2-33. (canceled)

34. At least one non-transitory computer-readable storage medium comprising instructions which, when executed by at least one processor causes the at least one processor to perform a method comprising:
determining information about a person or an environment using an output of an operation of an active reflective wave detector configured to measure wave reflections from an environment; and
based on the information, adapting one or more parameters of a triggering module used for starting a later operation of the active reflected wave detector to determine further information about the person or the environment, the later operation being started based on an output of a PIR motion detector that is arranged to monitor motion in the environment, the output indicating that a motion has occurred after said operation of an active reflective wave detector.

35. A device for method of controlling monitoring of a person or an environment, the device comprising:
a processor, wherein the processor is configured to:
determine information about a person or an environment using an output of an operation of an active reflective wave detector configured to measure wave reflections from an environment; and
based on the information, adapt one or more parameters of a triggering module used for starting a later operation of the active reflected wave detector to determine further information about the person or the environment, the later operation being started based on an output of a PIR motion detector that is arranged to monitor motion in the environment, the output indicating that a motion has occurred after said operation of an active reflective wave detector.

36. The device of claim 35, wherein the processor is configured to attempt to identify a state of a person to determine information about a person or an environment, wherein in an event of identifying a state of a person, the processor is configured to set the one or more parameters of the triggering module according to the state of the person.

37. The device of claim 35, wherein the processor is configured to attempt to identify an activity being performed by a person to determine information about a person or an environment, wherein in an event of identifying an activity being performed by a person, the processor is configured to set the one or more parameters of the triggering module according to the activity.

38. The device of claim 35, wherein the processor is configured to attempting to identify a position of a person relative to the PIR motion detector, wherein in an event of identifying a position of a person relative to the PIR motion detector, the processor is configured to set the one or more parameters of the triggering module according to the identified position of the person relative to the PIR motion detector, wherein the identified position of the person relative to the PIR motion detector comprises a determined distance of the person from the PIR motion detector.

39. The device of claim 38, wherein the one or more parameters configure motion detection performed by the PIR motion detector, and the adaption of the one or more parameters configures the motion detection for a range of distances from the PIR motion detector in which the PIR motion detector is expected to detect motion of a person, based on the identified position of the person.

40. The device of claim 38, wherein the identified position of the person relative to the PIR motion detector comprises one or more of:
a determined orientation of the person with respect to a principal axis of at least one lens of the PIR motion detector;
a determined spatial distribution of the person; and
a determined height of the person above a floor of the environment.

41. The device of claim 35, wherein the information about the person or the environment comprises information indicative of whether the person is or is not present in a monitoring region of the environment which is monitored by the active reflective wave detector, and in an event that the person is not present the processor is configured to set the one or more parameters of the triggering module to predetermined values associated with a vacant monitoring region.

42. The device of claim 35, wherein the one or more parameters configure motion detection performed by the PIR motion detector.

43. The device of claim 42, wherein the one or more parameters comprise one or more of:
a gain parameter defining a gain provided by a gain stage of the PIR motion detector;
at least one threshold parameter, the at least one threshold parameter defining at least one threshold used in a comparison stage of the PIR motion detector;
at least one frequency response parameter defining a frequency response profile of a gain stage of the PIR motion detector; and
a parameter defining a number of times a threshold used in an event processing stage of the PIR motion detector must be exceeded to detect motion.

44. The device of claim 35, wherein the processor is configured to:
determine a scenario based on the information; and
the adaption of one or more parameters of the triggering module comprises setting the one or more parameters based on the determined scenario.

45. The device of claim 44, wherein in response to controlling the PIR motion detector to be less sensitive to motion, the PIR motion detector is able to detect at least one of: (i) larger movements than movements detectable by the PIR motion detector when the one or more parameters of the triggering module are set to the predetermined values; (ii) faster movements than movements detectable by the PIR motion detector when the one or more parameters of the triggering module are set to the predetermined values; and (iii) movements of more surface area of a different temperature to a background than movements detectable by the PIR motion detector when the one or more parameters of the triggering module are set to the predetermined values; and
wherein the processor is configured to attempt to identify a state of a person or an activity performed by a person to determine information about a person or an environment, and the processor is further configured to:
(i) in an event of the scenario comprising a person being in a non-locomotory state or a person performing non-locomotory activity, set the one or more parameters of the triggering module to control the PIR motion detector to be less sensitive to motion than when the one or more parameters of the triggering module are set to predetermined values associated with at least one other scenario; or
(ii) in an event of the scenario comprising a person in a usually static state or person performing a usually static activity, set the one or more parameters of the triggering module to control the PIR motion detector to be less sensitive to motion than when the one or more parameters of the triggering module are set to predetermined values associated with at least one other scenario.

46. The device of claim 44, wherein the processor is configured to attempt to identify a state of a person or an activity performed by a person to determine information about a person or an environment, and in an event of the scenario comprising a person being in a usually static state or a person performing a usually static activity, the processor is configured to:
set the one or more parameters of the triggering module to confirmation setting values, for confirming that the person is still in a usually static state or performing a usually static activity, to control the PIR motion detector to be more sensitive to motion than when the one or more parameters of the triggering module are set to predetermined values associated with at least one other scenario;
determine whether a predefined condition has been met, the predefined condition relating to motion detections detected by the PIR motion detector; and
if the predefined condition has been met, set the one or more parameters of the triggering module to control the PIR motion detector to be less sensitive to motion than when the one or more parameters of the triggering module are set to the confirmation setting values.

47. The device of claim 35, wherein the later operation is started upon expiry of a time window that commences in response to the PIR motion detector detecting motion after said operation of the active reflective wave detector, and during which no further motion is detected by the PIR motion detector.

48. The device of claim 47, wherein the one or more parameters define a length of the time window.

49. The device of claim 48, wherein the processor is configured to:
determining a scenario based on the information; and
the adaption of one or more parameters of the triggering module comprises setting the length of the time window based on the determined scenario;
wherein the processor is configured to attempt to identify a state of a person or an activity performed by a person to determine information about a person or an environment, and the processor is further configured to:
(i) in an event of the scenario comprising a person being a non-locomotory state or a non-locomotory activity, set the length of the time window to be less than a predetermined value associated with at least one other scenario; or
(ii) in an event of the state or activity being a usually static state or a usually static activity, set the length of the time window to be less than a predetermined value associated with at least one other scenario.

50. The non-transitory computer-readable storage medium of claim 34,
wherein determining information about a person or an environment comprises attempting to identify a position of a person relative to the PIR motion detector, wherein in an event of identifying a position of a person relative to the PIR motion detector the method comprises setting the one or more parameters of the triggering module according to the identified position of the person relative to the PIR motion detector;
wherein the identified position of the person relative to the PIR motion detector comprises a determined distance of the person from the PIR motion detector; and
wherein the one or more parameters configure motion detection performed by the PIR motion detector, and the adapting the one or more parameters configures the motion detection for a range of distances from the PIR motion detector in which the PIR motion detector is expected to detect motion of a person, based on the identified position of the person.

51. The non-transitory computer-readable storage medium of claim 34,
wherein determining information about a person or an environment comprises attempting to identify a position of a person relative to the PIR motion detector, wherein in an event of identifying a position of a person relative to the PIR motion detector the method comprises setting the one or more parameters of the triggering module according to the identified position of the person relative to the PIR motion detector; and
wherein the identified position of the person relative to the PIR motion detector comprises one or more of:
a determined orientation of the person with respect to a principal axis of at least one lens of the PIR motion detector;
a determined spatial distribution of the person; and
a determined height of the person above a floor of the environment.

52. The non-transitory computer-readable storage medium of claim 34, wherein the one or more parameters configure motion detection performed by the PIR motion detector; and the one or more parameters comprise one or more of:
a gain parameter defining a gain provided by a gain stage of the PIR motion detector;
at least one threshold parameter, the at least one threshold parameter defining at least one threshold used in a comparison stage of the PIR motion detector;
at least one frequency response parameter defining a frequency response profile of a gain stage of the PIR motion detector; and
a parameter defining a number of times a threshold used in an event processing stage of the PIR motion detector must be exceeded to detect motion.
